(19) United States
(12) Patent Application Publication
(10) Pub. No.: US 2016/0055559 A1
(43) Pub. Date: Feb. 25, 2016

(54) System and Method for Managing Events

(71) Applicant: Corrine Leslie Heck, Ormond Beach, FL (US)

(72) Inventor: Corrine Leslie Heck, Ormond Beach, FL (US)

(21) Appl. No.: 14/828,668

(22) Filed: Aug. 18, 2015

Related U.S. Application Data
(60) Provisional application No. 62/039,069, filed on Aug. 19, 2014.

(51) Int. Cl. G06Q 30/06

(52) U.S. Cl. CPC G06Q 30/0621; G06Q 30/0641

(57) ABSTRACT

Embodiments of the present invention are directed to software for managing events and flower arrangements. The system may be implemented on a website, and in conjunction with databases related to vendor information and flower inventory. The invention enables locally owned flower shops to manage their inventory for customized events and arrangements through an easy to use computer interface. Features of the invention include creation and management of floral designs and recipes, custom contract templates, inventory management, expense projections and an extensive flower and resource catalog.

This application claims priority to U.S. Provisional Application Ser. No. 62/039,069 filed Aug. 19, 2014 which is incorporated herein by reference in its entirety.

### TECHNICAL FIELD

Embodiments of the invention are related generally to an application for systematically managing events and floral arrangements.

### BACKGROUND OF THE INVENTION

Current systems of managing events and floral arrangements for event designers and florists do not provide the flexibility needed to address the individual needs of a vast array of customers. Small event and floral arrangement providers in this $35 billion industry are experiencing increased pressure from larger businesses, such as supermarkets and online retailers. While small businesses make up the greatest component of the industry, consolidation is resulting in rising numbers of large-scale producers. Competition and cost pressures are forcing smaller production farms to close as the industry moves toward large-scale production. These increases in competition are forcing smaller entities to look for better ways to organize and provide services to their clients.

Further, despite improvements in the economy, the rising value of imports will continue to hamper industry growth. For instance, South American countries will remain the largest source of imported flowers, causing overall demand for domestic plants to suffer and increase competition. The floral industry requires a low capital investment, relying more significantly on human labor than on physical assets. In the past several years, the industry has generally increased its level of capital expenditure, mainly through the use of Point of Sale (“POS”) systems.

To combat this increase in competition, industry operators have adopted barcode scanning technology to computerize the inventory tracking and sales in their shops. Prior to this, technology sales were recorded manually or on cash registers. The introduction of POS systems is expected to simplify labor tasks and minimize the potential for employee mistakes. Further, interfacing the POS devices with a suite of flower and event management software applications should allow local owners to better keep track of their inventory and provide services more easily.

Solutions to the competitive floral and event management industry in the United States should be easy to implement and will have broad-ranging capabilities. These solutions should allow florists and event managers to quickly and easily navigate their inventory on a user friendly interface and to create events and arrangements that will satisfy their customers.

### SUMMARY OF THE INVENTION

Embodiments of the present invention are directed to software and/or software applications, systems and methods for managing events. In particular, embodiments of the invention are directed towards an event management software platform for local florists and event managers that handle all floral designs and recipes, custom contract templates, inventory management, expense projections and an extensive flower catalog. The platform may also allow florists and event managers to sell their own products at their own prices. The event management software platform may perform a variety of business functions, such as, for example, tracking clients, managing orders, storing digital and printed contracts, setting and tracking deadlines, storing company preferences, storing custom presentations, and managing budget and expense reports. Although the event management software platform discussed below relates to the floral industry, it may also be applied to several other industries with similar requirements (e.g., general contracting, architecture, interior design, etc.).

The proposed system and method for improving the ease of creating and managing events and floral arrangements will allow event managers and local florists to compete with supermarkets and large online retailers. Further, it will allow them to manage their own business without paying any commissions to wire services, etc. The present invention allows owners to create custom contracts for their customers, design floral arrangements and recipes and manage shop inventory. The system also organizes flowers and/or “blooms” by color, price, season and country.

According to an embodiment, the invention is directed towards allowing local florists to create a website that users can efficiently navigate. The user may sign up and log into the website through a portal. The website may provide relevant and user-friendly information for customers and/or users to create their own floral arrangement or event. The website may price out each element in a bouquet (“recipe”) for flowers or events and include all the floral design and recipes, custom contract templates, inventory management, expense projections and an extensive flower catalog.

According to an embodiment of the invention, the system may enable the florist to organize his or her arrangements while viewing pictures and/or photographs of the flowers. Further, it may update the florist's inventory and keeps track of past arrangements, some of which may be proprietary or “signature.” The florist may use the Flower Catalog which organizes blooms by color, price, season and country. Further, the florist may work directly with the growers and manufacturers to ensure maximum freshness and minimize waste through the online interface. These aspects of the platform may be limited in their availability based on the level of user access granted, and may be tiered according to the organization functionality of the platform, the sharing and inspiration from other platform users, and the connecting with growers and florists.

According to an aspect of the invention, the platform may enable users to collaborate with other users of the platform. Users may be able to share their creations and recipes, along with portfolios of events to garner feedback and gather new ideas. Further, it may allow users to unite with farms, manufacturers and suppliers to deliver answers to questions about the products, opportunities to forecast orders and to create alliances to lower costs. In embodiments of the invention, the system may allow for multiple users of the system to collaborate, allowing, e.g., a florist, to communicate directly with e.g., a supplier of flowers, such as a farm or cooperative. This may allow the joint users to have direct and immediate access to cost information, as well as any other information that might be relevant to their business relationship. The user may also be able to interface with social media sites (e.g., Facebook™, Twitter™, Pinterest™, etc.) to collaborate on designs and share them with a wider audience.

According to an aspect of the invention, the platform contains accounting tools to send invoices, collect deposits, pay vendors, track pricing and even connect to existing systems like QuickBooks or banking statements. Users can coordinate multiple orders, set up routine deliveries, track pricing, request quotes, make notes regarding staff or service, and maintain an online address book for every vendor. Contracts for each vendor and customer can be made through customizable contract templates by selecting the necessary terms and the platform will create the document. Digital copies of the signed documents can be saved as well for future reference.

According to an aspect of the invention, there is an inventory manager allowing real time access. The user can even verify signatures and calculate necessary quantities for future orders. This capability may be combined with a flower resource guide for specifying, for instance, which blooms are in seasons, and what suitable alternatives exist based on live pricing from vendors. Terms from linen providers can also be included to know what's in production, where it is being shipped and trends that are in the future. The platform also provides access to daily floral auctions, and allows the user to name the price and quantity and see what growers respond to the need. The user can also partner up with other platform users to service clients through a large nationwide network of floral professionals.

According to an aspect of the invention, a user can create a blog through a blog creation functionl. The blog can link to arrangements and events and a customized template is provided to the user.

According to an embodiment of the invention, users can set up an event with a “one-touch” event setup. This feature fills in all the dates related to a single event, including reminders, deliveries, deposit dates, and other milestones based on a customizable timeline and preference. The software platform also allows users to create thorough checklists and manage recipes from prior events by entering criteria such as type of event, bloom, color, and theme.

According to an embodiment of the invention, the platform has a Contract Designer and Sales Guide that give step-by-step instructions for users to create events. Images are available for reference with description of items used for each event. Contracts may include terms, percentages and delivery charges. Data and preferences may also be saved for each user. Also, checklists and scheduling can be automated and can be kept monitored from any place where there is a secure internet connection.

### BRIEF DESCRIPTION OF THE DRAWINGS

The present invention is described in detail below with reference to the attached drawings figures, wherein:

FIG. 1A is a block diagram illustrating an operating environment for an Event Management System in accordance with an embodiment of the invention;

FIG. 1B is a block diagram illustrating an operating environment for an Event Management System in accordance with an embodiment of the invention;

FIG. 2 is a user interface illustrating a Web Dashboard of an Event Management System in accordance with an embodiment of the invention;

FIG. 3 is a user interface illustrating a Web Dashboard of an Event Management System in accordance with an embodiment of the invention;

FIG. 4 is a user interface illustrating a Web Dashboard of an Event Management System in accordance with an embodiment of the invention;

FIG. 5 is a user interface illustrating a Web Dashboard of an Event Management System in accordance with an embodiment of the invention;

FIG. 6A is a user interface illustrating a Web Dashboard of an Event Management System in accordance with an embodiment of the invention;

FIG. 6B is a user interface illustrating a Web Dashboard of an Event Management System in accordance with an embodiment of the invention;

FIG. 7 is a user interface illustrating a Web Dashboard of an Event Management System in accordance with an embodiment of the invention;

FIG. 8 is a user interface illustrating a Web Dashboard of an Event Management System in accordance with an embodiment of the invention;

FIG. 9 is a user interface illustrating a Web Dashboard of an Event Management System in accordance with an embodiment of the invention;

FIG. 10A is a user interface illustrating a Web Dashboard of an Event Management System in accordance with an embodiment of the invention;

FIG. 10B is a user interface illustrating a Web Dashboard of an Event Management System in accordance with an embodiment of the invention;

FIG. 10C is a user interface illustrating a Web Dashboard of an Event Management System in accordance with an embodiment of the invention;

FIG. 11 is a user interface illustrating a Web Dashboard of an Event Management System in accordance with an embodiment of the invention;

FIG. 12A is a user interface illustrating a Web Dashboard of an Event Management System in accordance with an embodiment of the invention;

FIG. 12B is a user interface illustrating a Web Dashboard of an Event Management System in accordance with an embodiment of the invention;

FIG. 13 is a user interface illustrating a Web Dashboard of an Event Management System in accordance with an embodiment of the invention;

FIG. 14 is a user interface illustrating a Web Dashboard of an Event Management System in accordance with an embodiment of the invention;

FIG. 15 is a user interface illustrating a Web Dashboard of an Event Management System in accordance with an embodiment of the invention;

FIG. 16 is a user interface illustrating a Web Dashboard of an Event Management System in accordance with an embodiment of the invention; and

FIG. 17 is a user interface illustrating a Web Dashboard of an Event Management System in accordance with an embodiment of the invention.

FIGS. 18A-G is an exemplary contract document generated by the Event Management System in accordance with an embodiment of the invention.

FIGS. 19A-I is an exemplary recipes document generated by Event Management System in accordance with an embodiment of the invention.

### DETAILED DESCRIPTION OF PREFERRED EMBODIMENTS

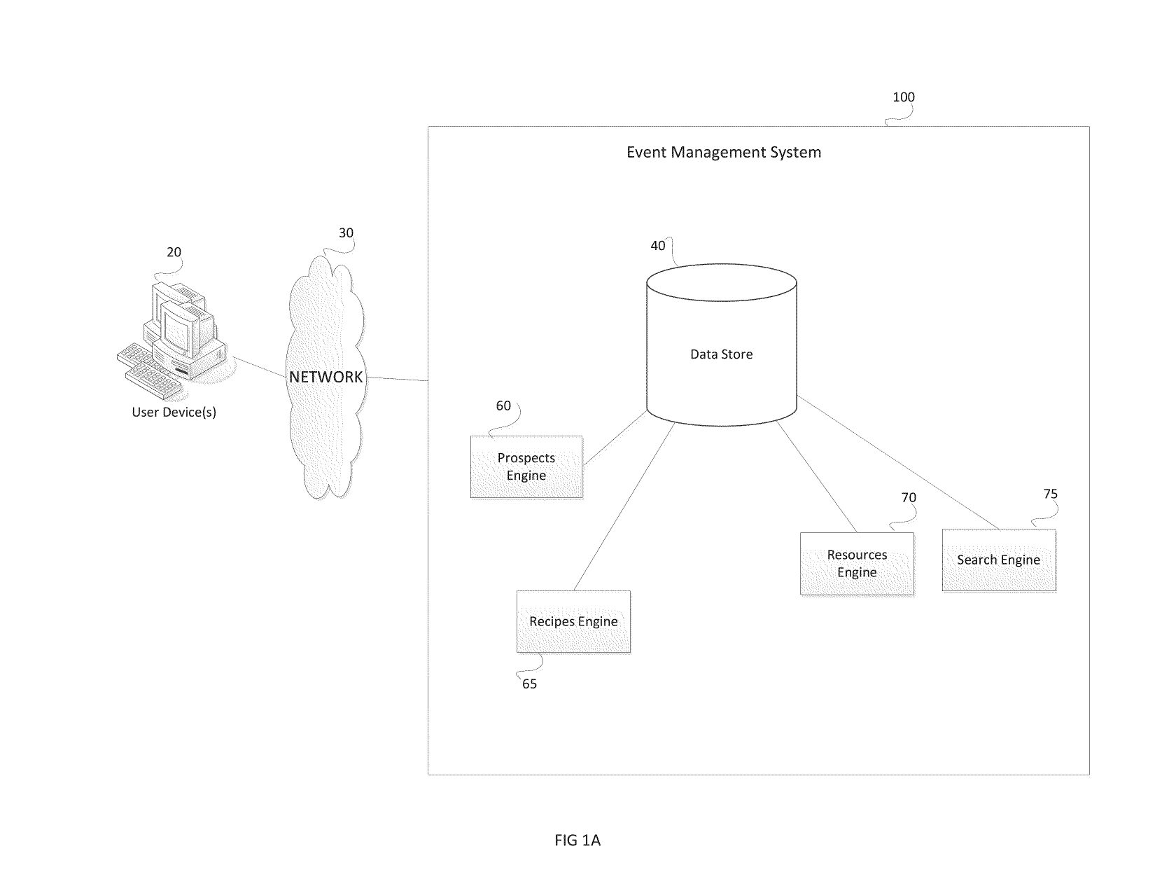

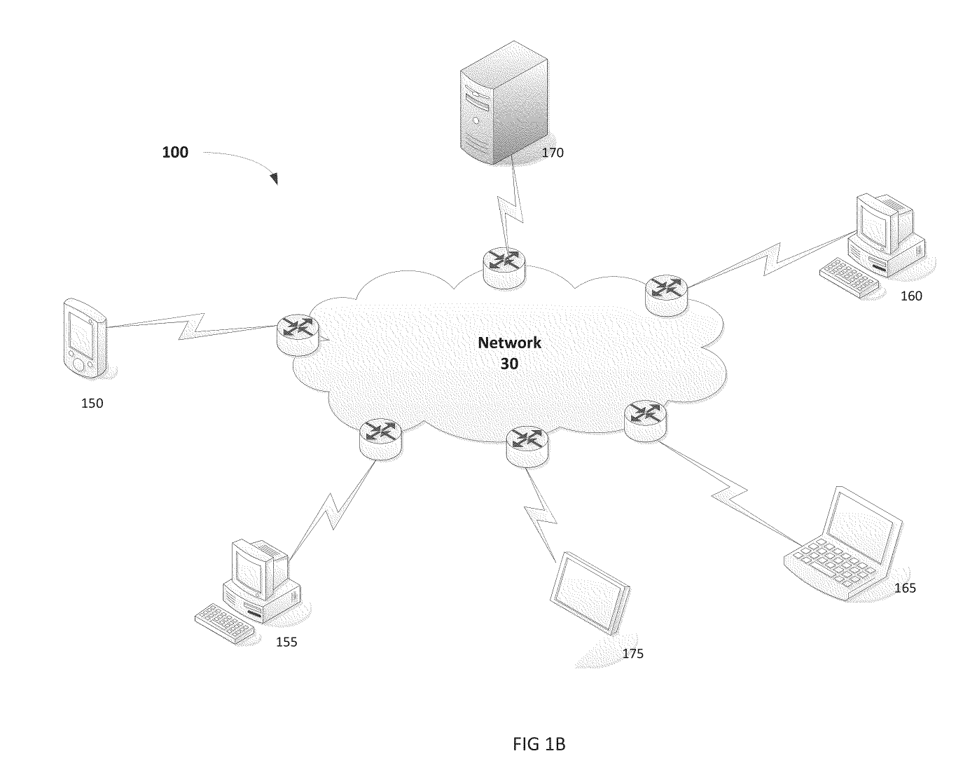

Exemplary embodiments of the invention are shown in FIG. 1A. FIG. 1A is a block diagram illustrating an operating environment for an Event Management System in accordance with an embodiment of the invention. The Event Management System 100 is connected through a communications medium over a Network 30, such as the internet, an intranet, a local-area-network (LAN), a wide-area-network (WAN), etc., to one or more User Devices 20. The User Devices 20 may allow a user to enter information regarding one or more events (and related data) and also to access available information relating to events. The Event Management System 100 includes a Data Store 40, a Prospects Engine 60, a Recipes Engine 65, a Resources Engine 70, and a Search Engine 75. In an embodiment of the invention, the Data Store 40 may be a database that is local to the Event Management System 100 and that stores data to be used by the Event Management System 100 to perform event management.

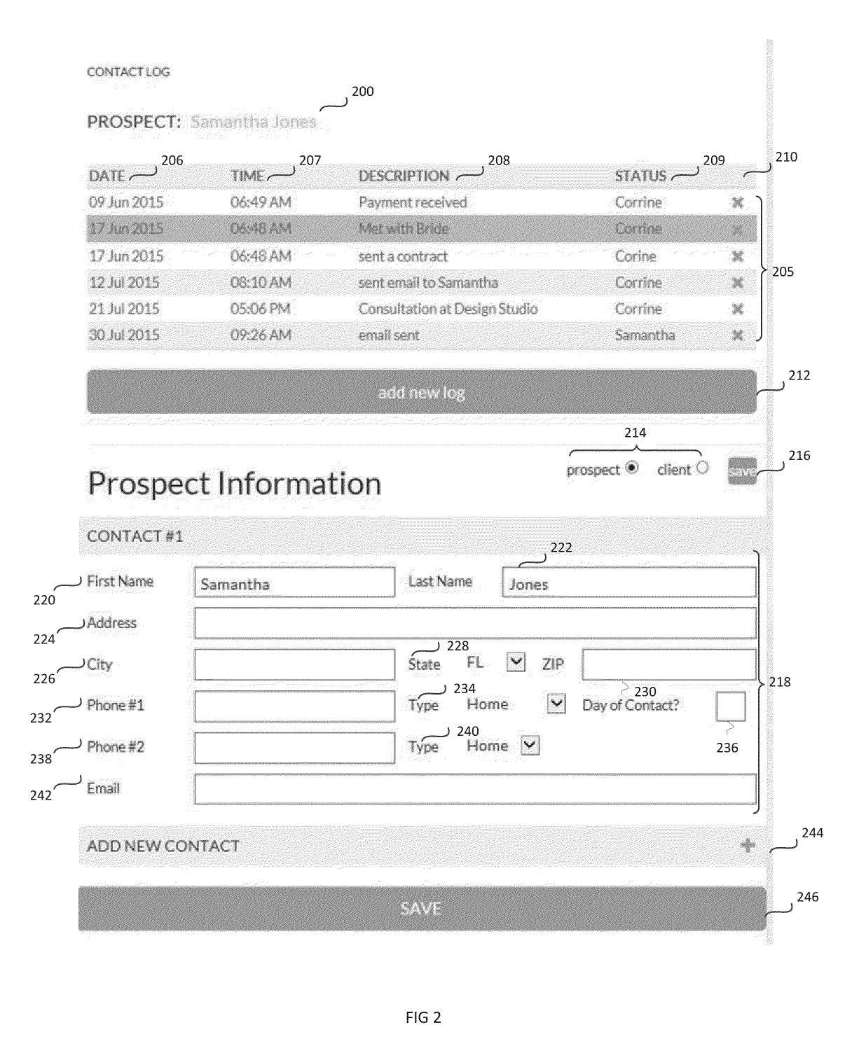

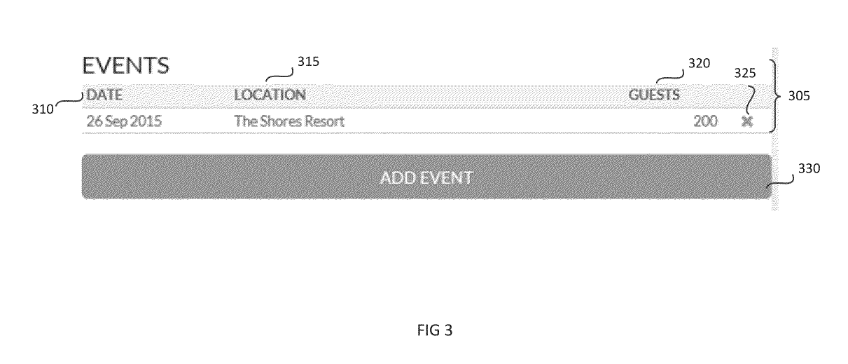

A user may access the Event Management System 100 using a web browser. In an embodiment of the invention, a user is prompted to provide authentication information before access to the Event Management System 100 is granted. Examples of authentication information include, but are not limited to, username, user id, password, biometrics, etc. Once a user is authenticated, he/she may be able to perform several actions using the Web Dashboard(s) 50. For example, a user may be able to create a new prospect and/or client using the information entered by the user. Examples of prospects include, but are not limited to, an individual, a corporation, a charity foundation, etc. A Web Dashboard for managing prospect and/or client information is described in greater detail in reference to FIG. 2. The user may also be able to add one or more events associated with a prospect, and manage event details, such as event estimate, design worksheet(s), miscellaneous fees, costs, payment(s), contract for the event, and recipes used for the event. For example, a user may be able to add a wedding event for a prospective bride. Examples of Web Dashboards for managing events and event details are described in greater detail in reference to FIGS. 3-9. After receiving information about prospects and their events, the Prospects Engine 60 may use the information to generate one or more contracts associated with the event(s).

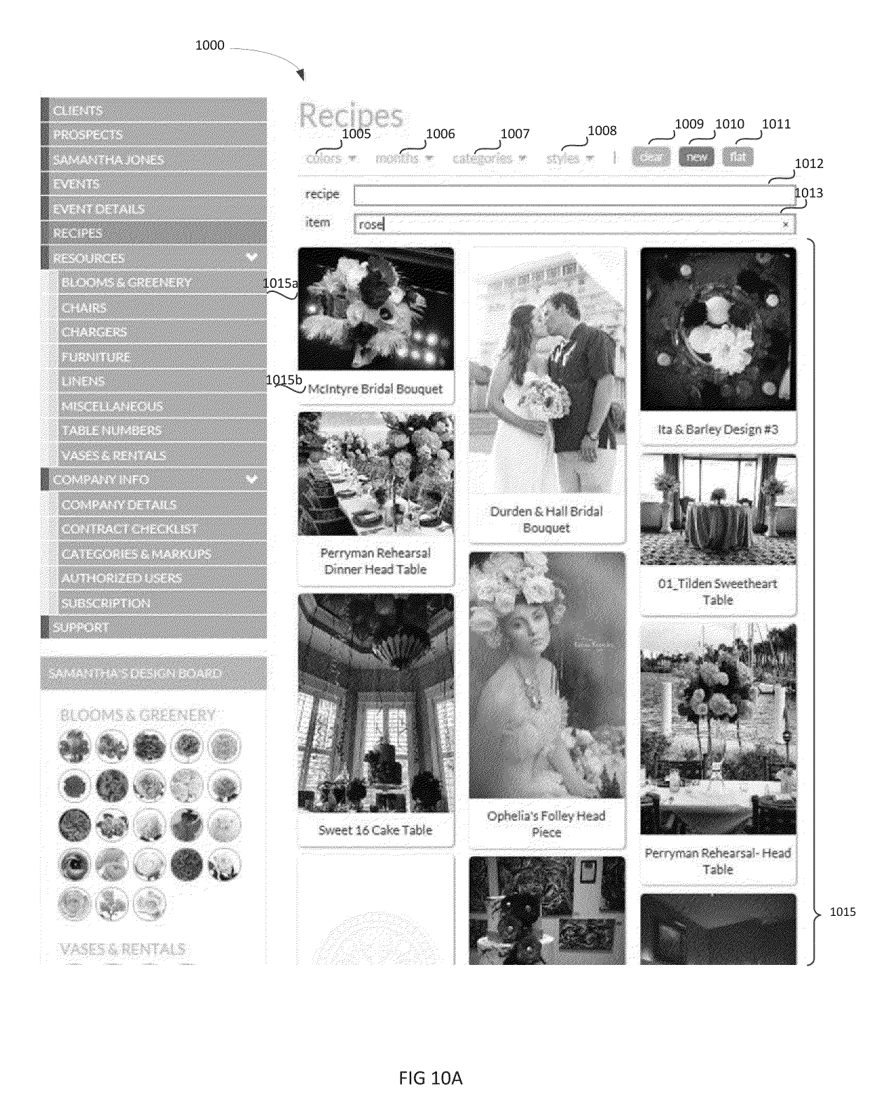

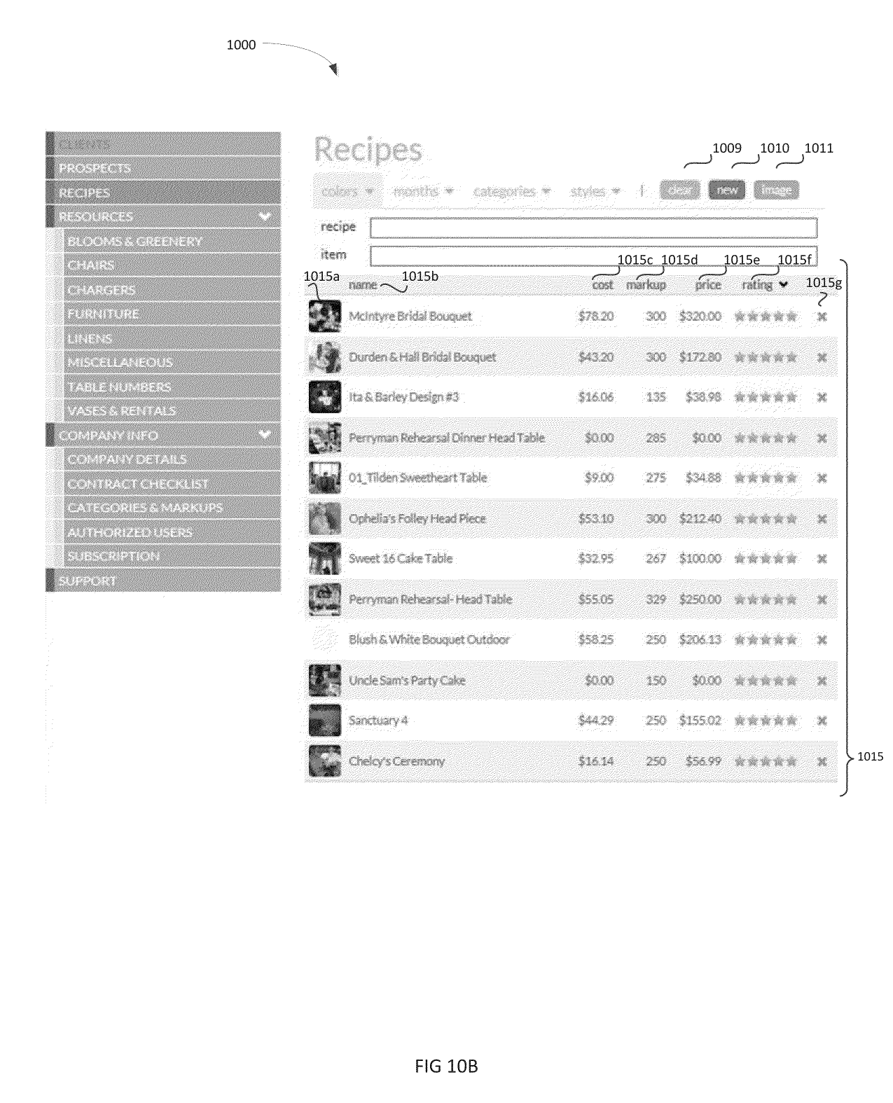

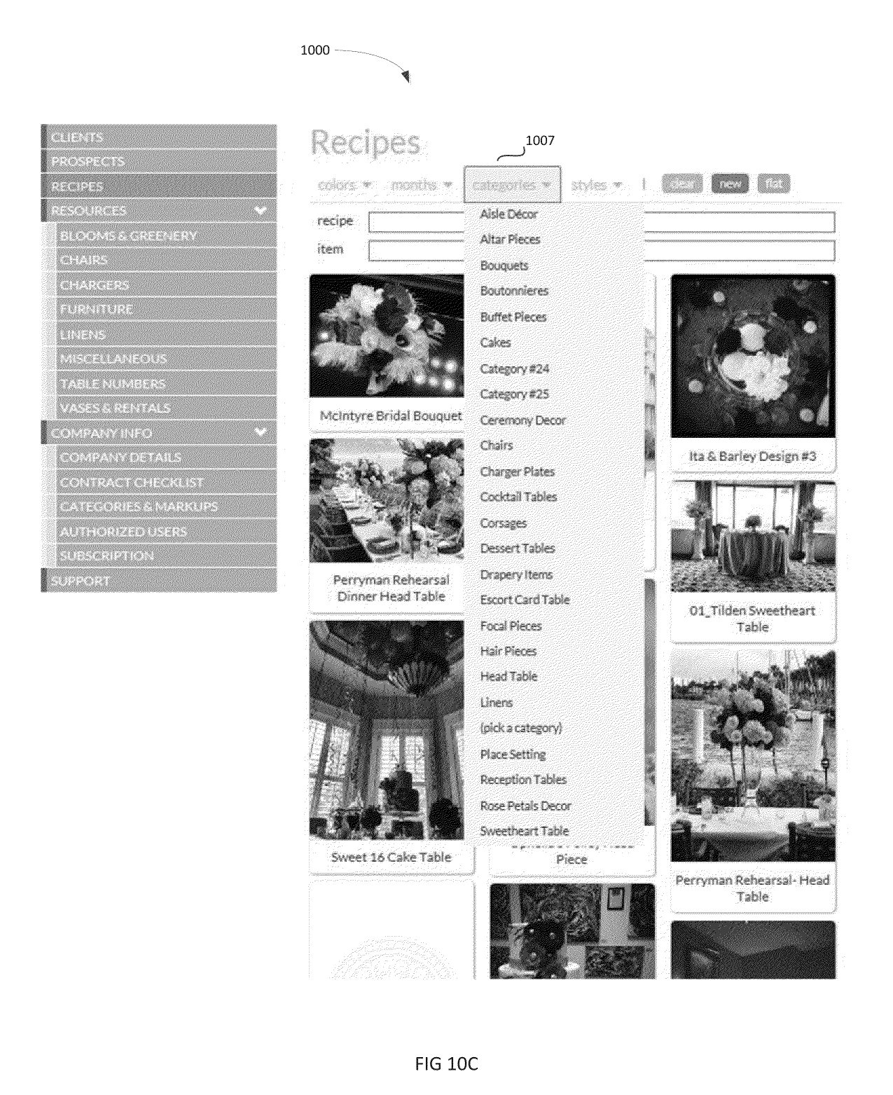

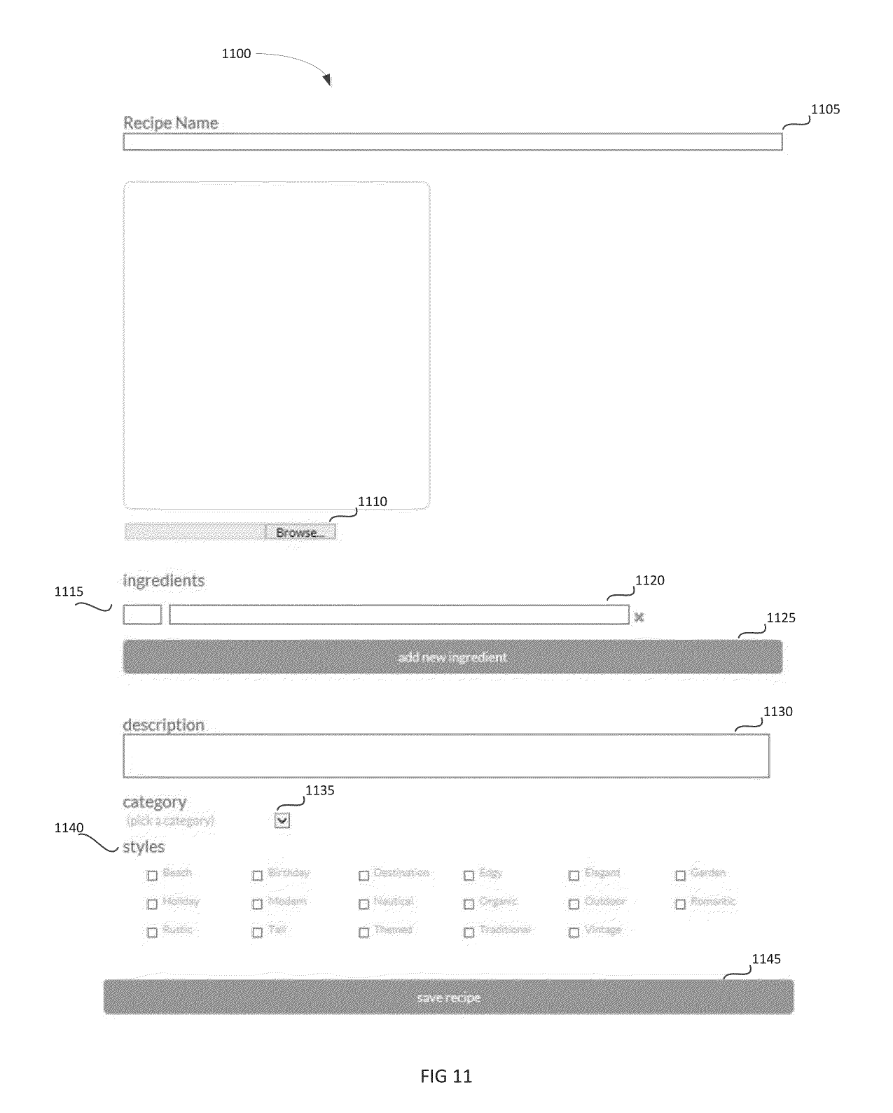

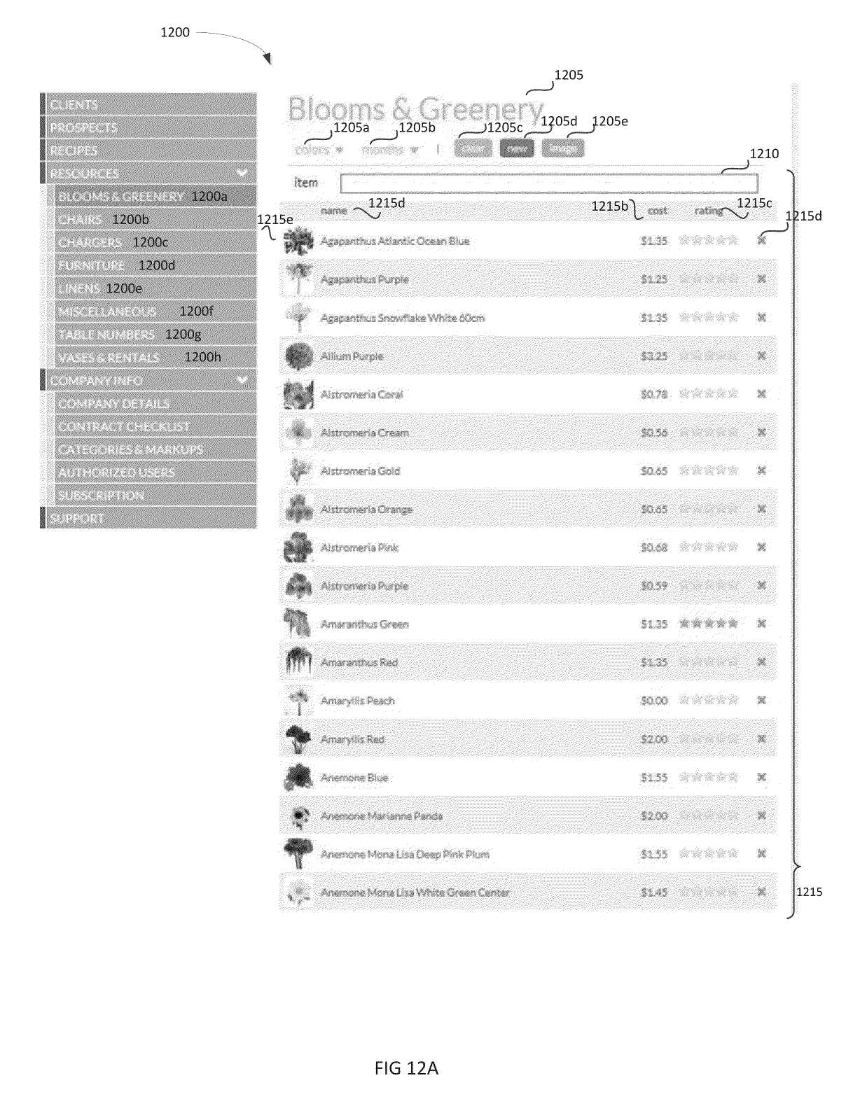

A user may be able to search for and/or create one or more recipes for an item. For example, a user may be able to create a particular flower bouquet that is comprised of selected flowers of certain colors, fragrance, shapes, etc. A user may be able to create a recipe for a particular dish, such as a cake, cookie, etc. In an embodiment of the invention, a user may be able to create a recipe for a layout of a room, such as the layout of a dining room, by specifying various furniture and furnishing pieces and their locations. The user may associate a new recipe with a name, description, category, ingredients, etc. A recipe is a broad term to encompass a collection of objects that are related to a topic of interest to the user. A user may be able to search for one or more saved recipes using search criteria. Examples of Web Dashboards for managing recipes are described in greater detail in reference to FIGS. 10A-11. After receiving information about an event, the Recipes Engine 65 may use the information to search for and/or generate one or more events.

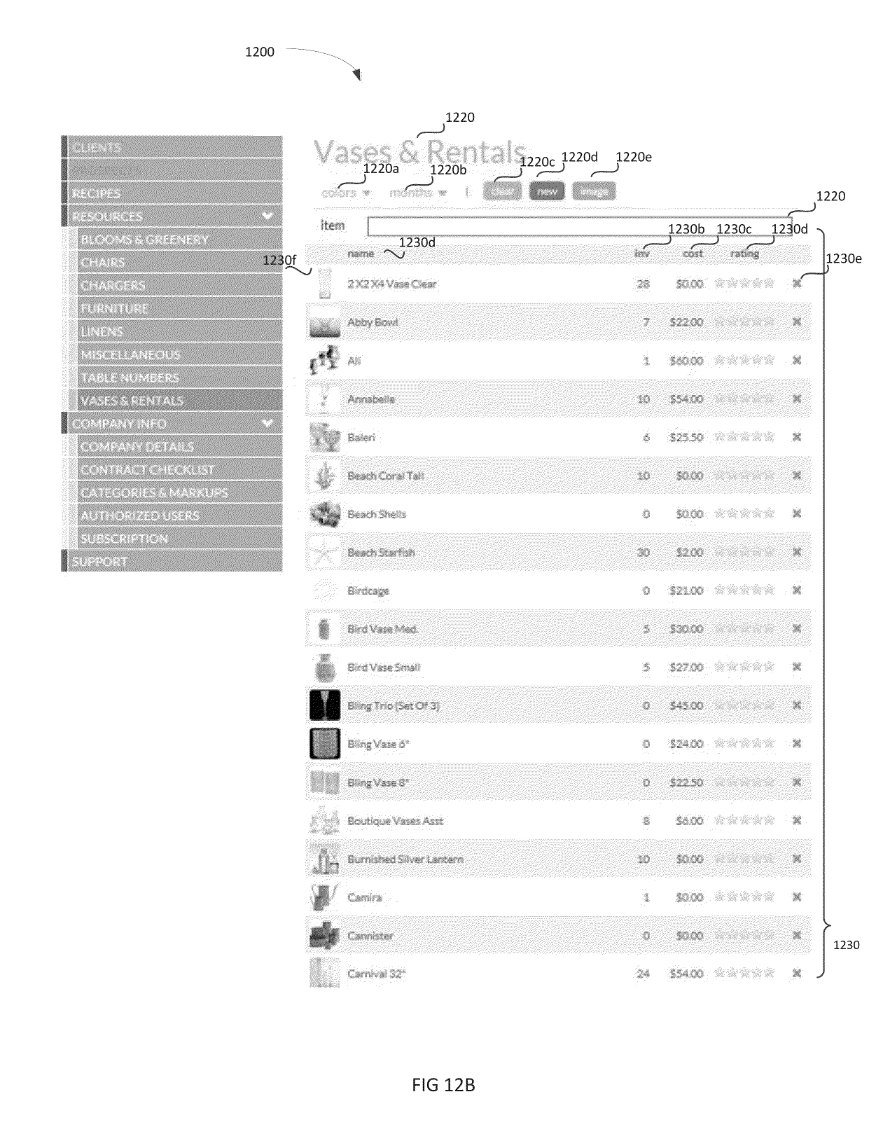

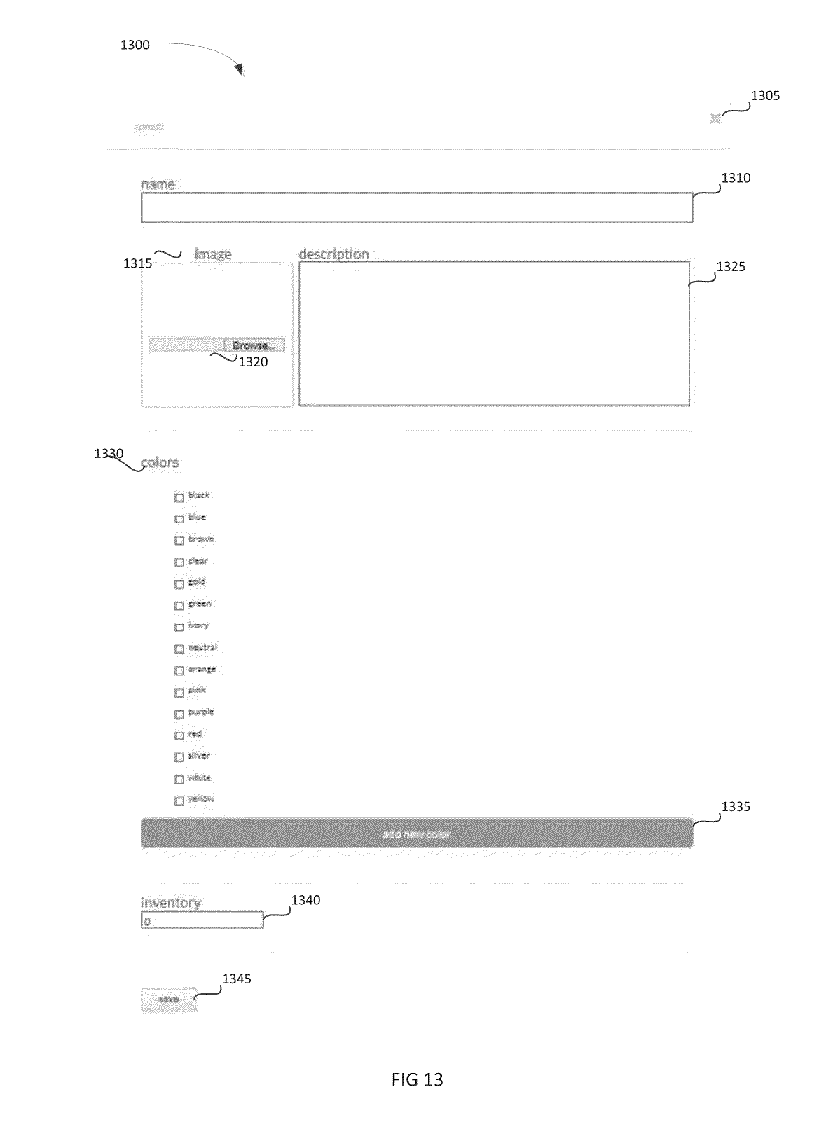

A user may be able to manage one or more resources that are required for an event. For example, a user may be able to manage the inventory of blooms and greenery that may be used to create bouquets, flower arrangements, boutonnieres, etc. for a wedding. The user may be able to specify the furniture required for a party. Other examples of resources include, but are not limited to, chairs, chargers, linens, table numbers, vases and rental, and other miscellaneous resources. A user may be able to create a new resource to add to the inventory. Examples of Web Dashboards for managing resources are described in greater detail in reference to FIGS. 12A-13. After receiving information about a resource, the Resources Engine 70 may use the information to search for and/or generate one or more resources.

In an embodiment of the invention, a user may be able to perform simple and/or complex searches on the data saved in the data store using the Search Engine 75. For example, the user may be able to search for all recipes that use a certain resource (e.g., search for all bouquets that contain a red rose). In an embodiment of the invention, a user may be able to search not just the data stored in the Data Store 40, but also information available on the Internet and one or more social media websites. For example, a user may be able to search for all bouquets with a red rose that have been discussed and/or posted by people in the user's social network (e.g., by searching the user's Facebook™, Twitter™ and Pinterest™ accounts).

FIG. 1B is a block diagram illustrating an operating environment for an Event Management System 100 in accordance with an embodiment of the invention. Those skilled in the art will appreciate that the invention may be practiced with various computer system configurations, including hand-held wireless devices such as mobile phones, smart phones or Personal Digital Assistants (PDAs) 150, multiprocessor systems 155, microprocessor-based or programmable consumer electronics 160, minicomputers 165, mainframe computers 170, Tablets (iPad™, Samsung Galaxy™, etc.) 175, and the like. The invention may also be practiced in distributed computing environments where tasks are performed by remote processing devices that are linked through a communications network 30. In a distributed computing environment, program modules may be located in both local and remote computer storage media including memory storage devices.

Generally, it should be noted that the components depicted and described herein above may be, or include, a computer or multiple computers. Although the components are shown as discrete units, all components may be interconnected or combined. The components may be described in the general context of computer-executable instructions, such as program modules, being executed by a computer. Generally, program modules include routines, programs, objects, components, data structures, etc., that perform particular tasks or implement particular abstract data types.

FIG. 2 is a is a user interface illustrating a Web Dashboard of an Event Management System in accordance with an embodiment of the invention. Specifically, FIG. 2 illustrates a Web Dashboard 200 for viewing a prospect and information associated with the prospect. In an exemplary embodiment of the invention, once the user signs up through a portal with a user name and password, the user is directed to the client/prospect management dashboard illustrated in FIG. 2. In an embodiment of the invention, prior to arriving at the Web Dashboard illustrated in FIG. 2, a user may be able to search for and select a prospect. Upon selecting the prospect, the user may be presented with the Web Dashboard illustrated in FIG. 2 that lists the name of the prospect 200 and a contact log 205 that displays the date 206, time 207, description 208 and status 209 of one or more contact events with the prospect. For example, the contact log 205 may display that the prospect Samantha Jones was contacted on Jun. 12, 2015 at 8:10 AM via email by Corrine. A user may be able to add new entries to the contact log 205 by selecting the button 212. A user may be able to delete entries from the contact log 205 by selecting a delete button 210. Web Dashboard 200 may also display information about the prospect including one or more people to contact. The user may be able to denote, using field 214, that the contact is a client or a prospect. For example, once a contract is signed between the user and the contact, he/she may become a client. The user may then denote the contact as a client, using field 214, and save the change using button 216. The user may be able to view and/or modify details about the contact, including, first name 220, last name 222, address 224, city 226, state 228, zip 230, phone number one 232, type of phone number 234 (e.g., home, cell, work, etc.), day of contact 236, phone number two 238, type of phone number 240 (e.g., home, cell, work, etc.), and email 242. The user may be able to add a new contact to the prospect by selecting button 244. The user may save the changes using the button 246.

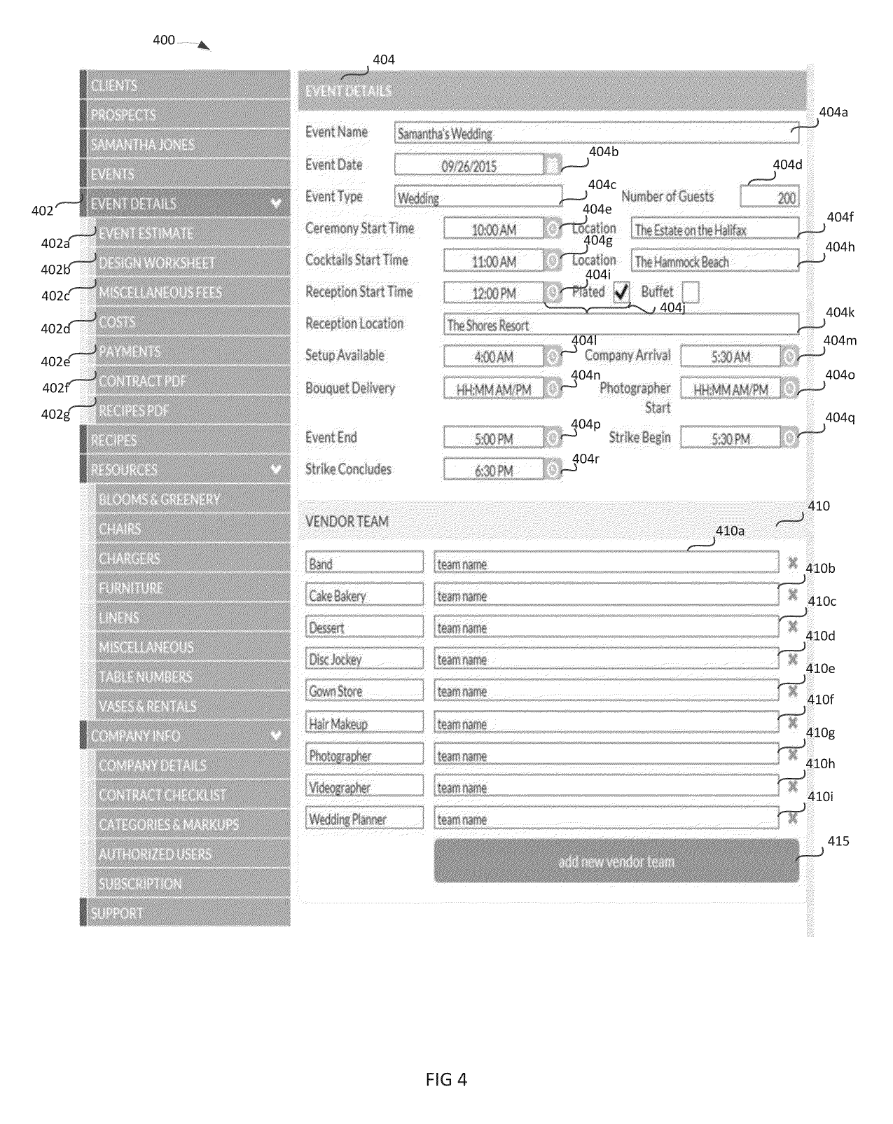

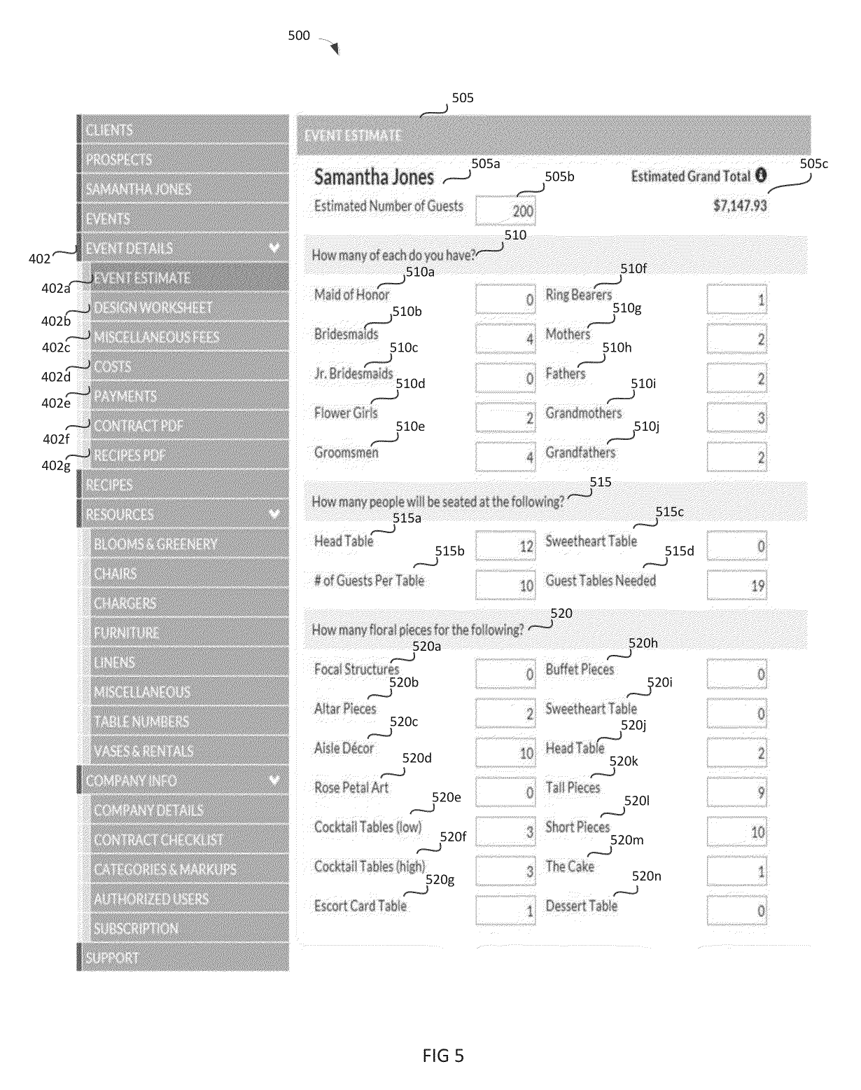

The user may be able to view one or more events associated with a prospect using, for example, the Web Dashboard illustrated in FIG. 3. The Events Dashboard 305 may display the date of the event 310, the location of the event 315 and the number of guests 320. The user may be able to delete an event by selecting button 325. The user may be able to add an event by selecting button 330. Upon selecting button 330 to add an event, the user may be directed to a Web Dashboard illustrated in FIG. 4. Specifically, FIG. 4, illustrates an Events Dashboard 400 that comprises an Event Details dashboard 404 that may enable a user to add/edit details about an event. A user may be able to add the following details about an event: event name 404a, event date 404b, event type 404c and number of guests 404d. The user may also specify details for one or more sub-events that may comprise a larger event. For example, the user may be able to specify the following details about the sub-events associated with a wedding: ceremony start time 404e, ceremony location 404f, cocktails start time 404g, cocktails location 404h, reception start time 404i and reception location 404k. The user may also specify further attributes of the events, such as whether the reception is plated or buffet style (404j). The user may specify the setup time availability 4041, the company arrival time 404m, bouquet delivery time 404n, photographer start time 404o, event end time 404p, strike begin time 404q, and strike conclude time 404r. The user may also specify one or more details about the vendor team(s) who will be involved in the event using the Vendor Details dashboard 410. Specifically, the user may view and/or edit the vendor type and the vendor name. For example, the user may specify details of the following vendors associated with a wedding: band 410a, cake bakery 410b, dessert 410c, disc jockey 410d, gown store 410e, hair/makeup 410f, photographer 410g, videographer 410h, and wedding planner 410i. The user may be able to add a new vendor team by selecting button 415, or delete an existing vendor team.

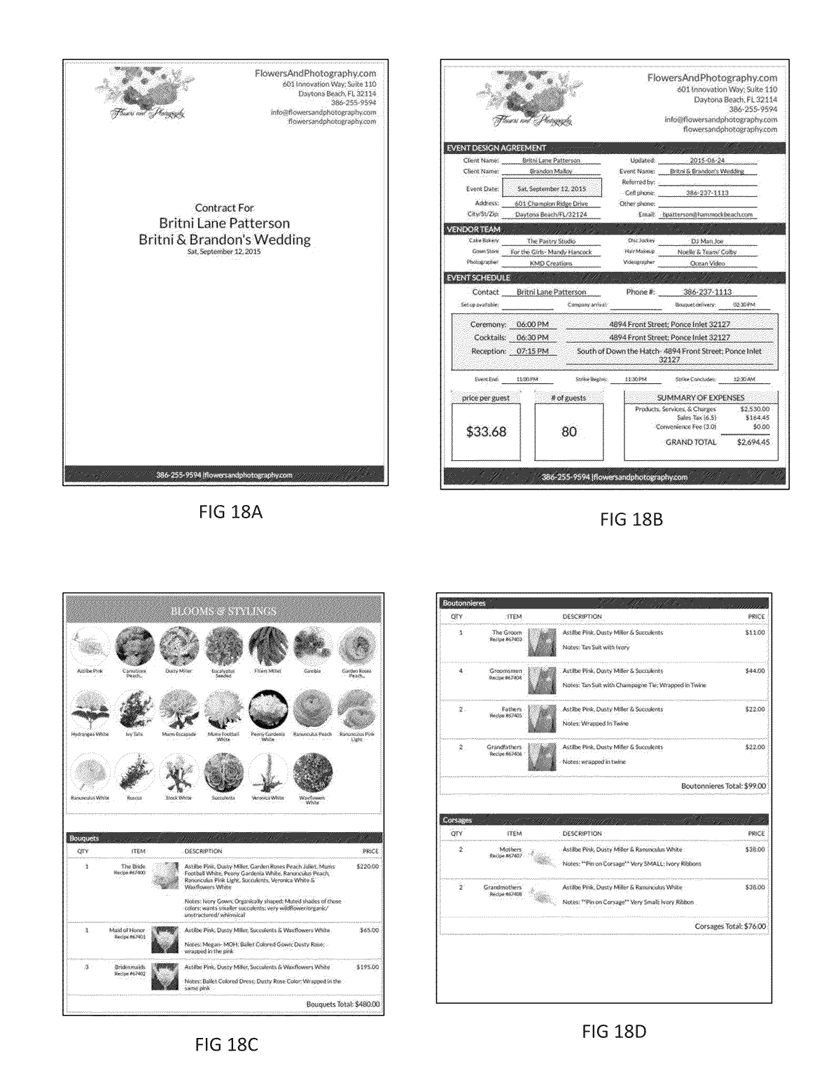

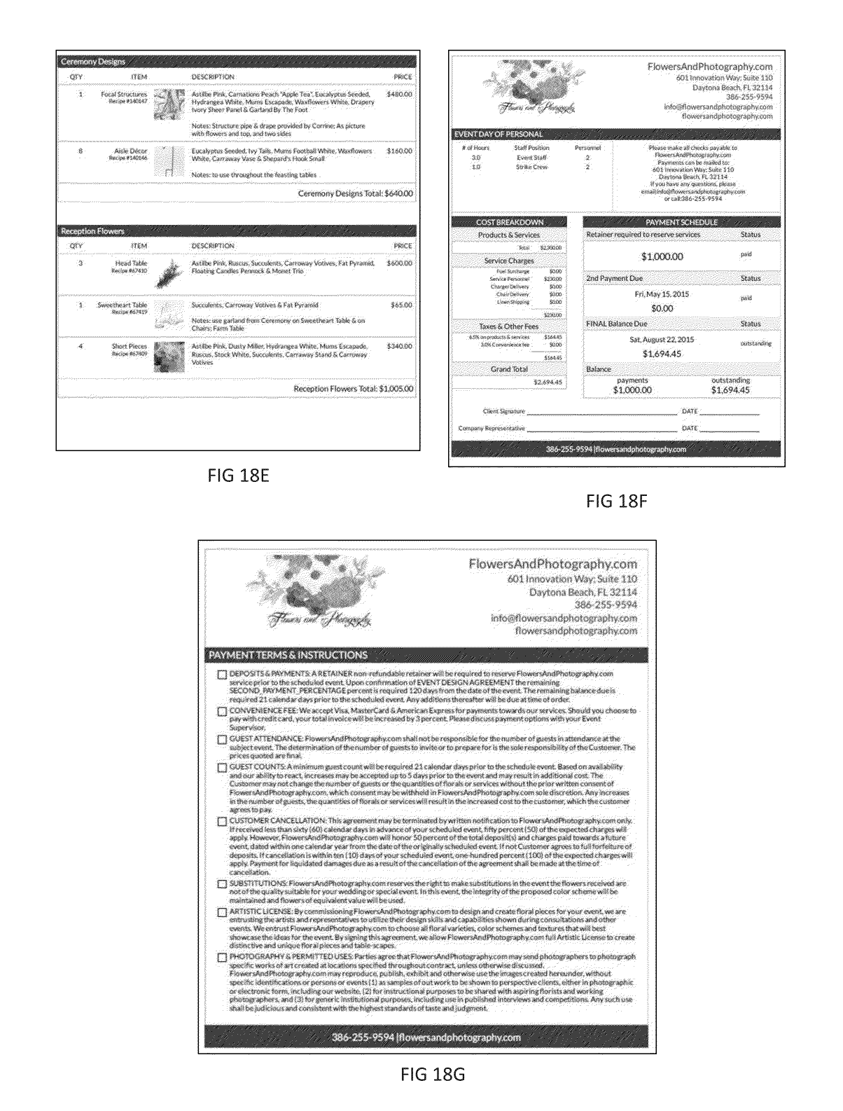

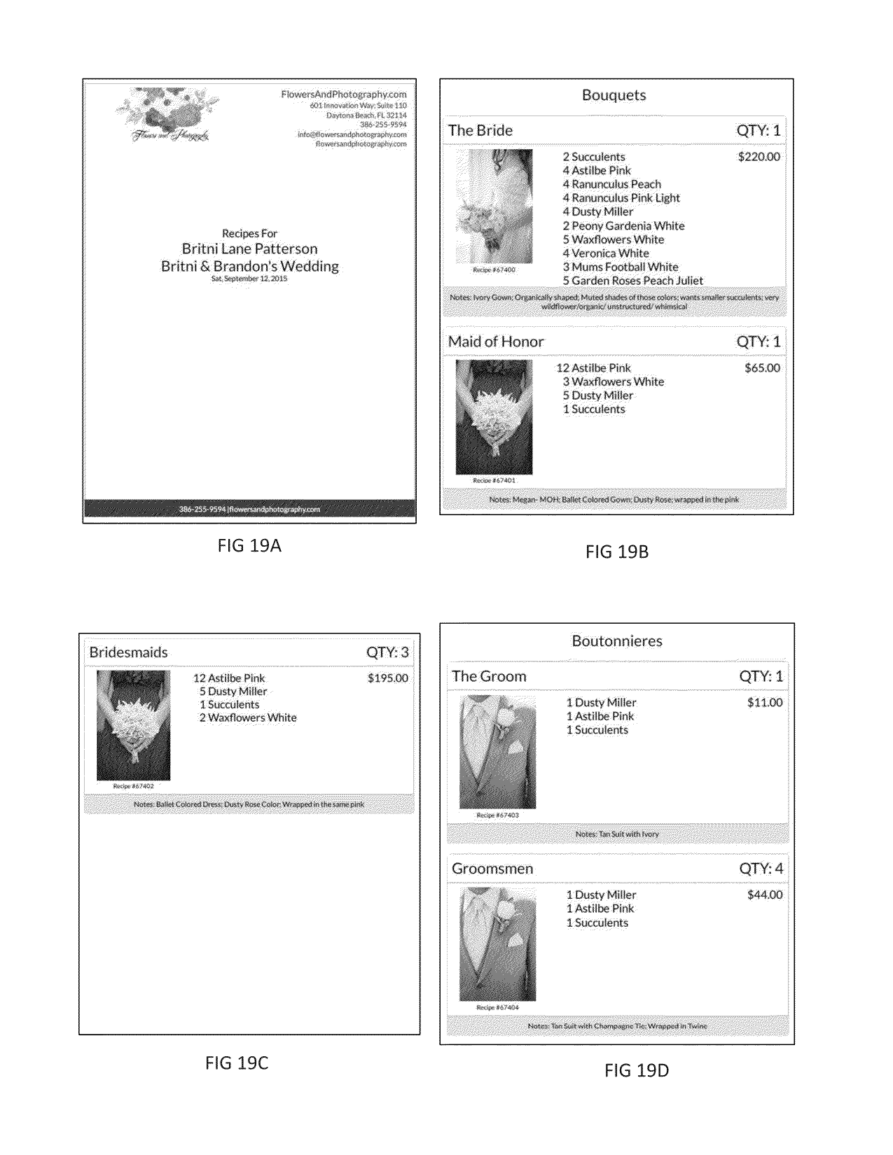

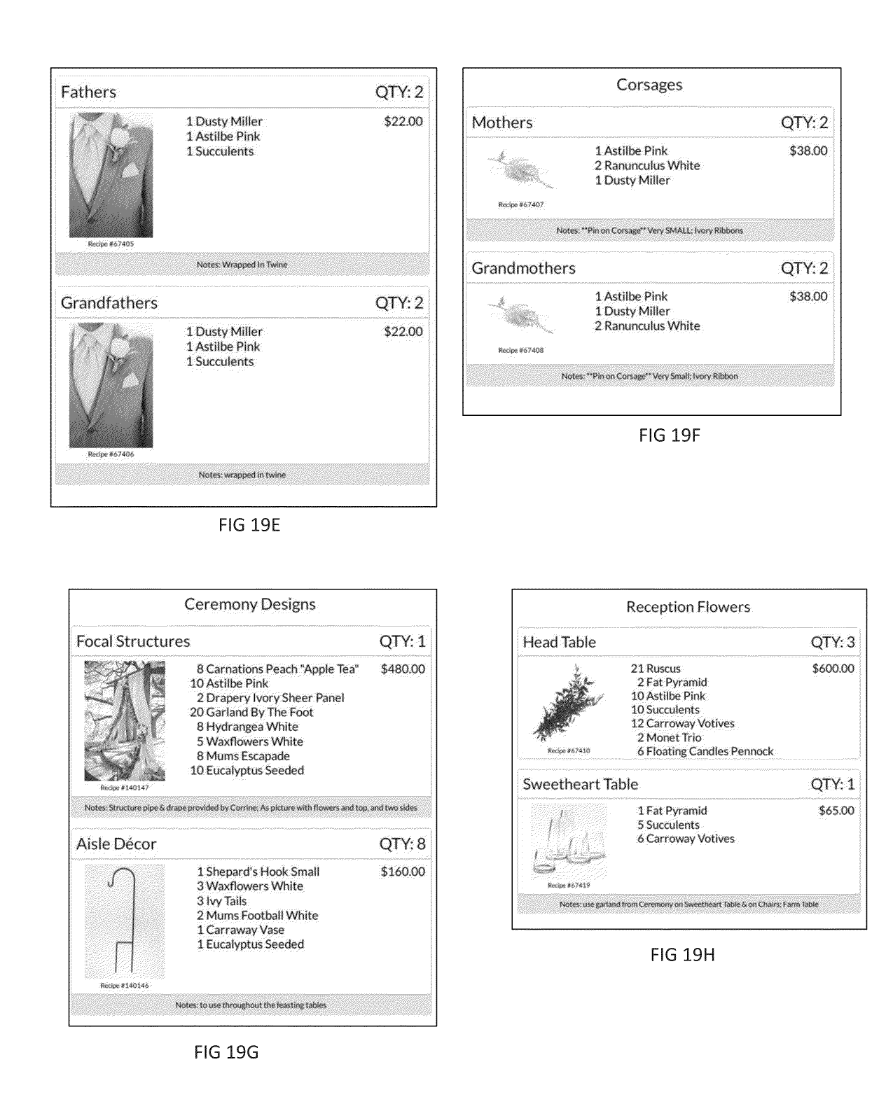

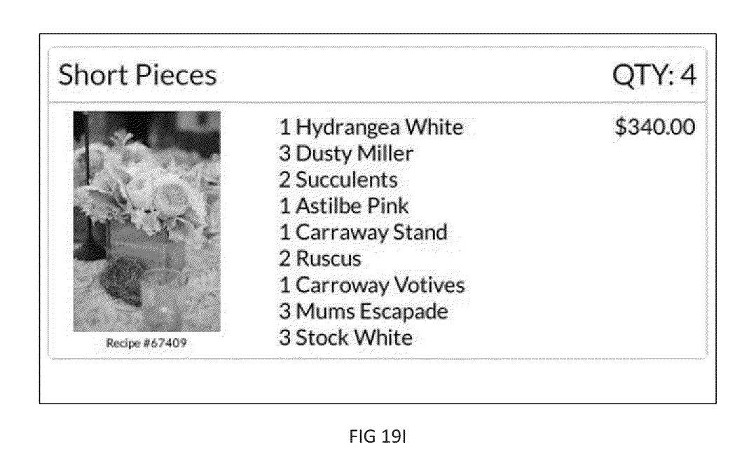

The user may be able to specify additional details associated with an event (402) by selecting one or more dashboards, such as event estimate 402a, design worksheet 402b, miscellaneous fees 402c, costs 402d, payments 402e, contract pdf 402f and recipes pdf 402g. Upon selecting contract pdf 402f, the user may be presented with a contract that illustrates the various attributes and selections for the event(s). FIGS. 18A-G describe an example of a contract document. The user may be able to transmit the contract to one or more users (e.g., the contacts associated with the prospect). The user may be able to publish the contract to a website and share it with one or more users (e.g., via email, social media, etc.). Upon selecting recipes pdf 402f, the user may be presented with a summary of the recipes used at the event(s). FIGS. 19A-I describe an example of a recipes document. The user may be able to transmit the recipe pdf to one or more users (e.g., the contacts associated with the prospect). The user may be able to publish the recipe pdf to a website and share it with one or more users (e.g., via email, social media, etc.).

When a user selects the events estimate button 402a, he/she may be directed to an Event Estimate Dashboard 500 as illustrated in FIG. 5. The Event Estimate dashboard 500 may comprise a section on event estimate 505. It may display the name of the prospect 505a, the estimated number of guests at the event 505b, and the estimated grand total for the event 505c. The user may be able to modify the estimated number of guests 505b. The user may be able to specify the components of the event that may impact the estimated grand total. For example, for a wedding event, the user may specify the number of maids of honor 510a, bridesmaids 510b, junior bridesmaids 510c, flower girls 510d, groomsmen 510e, ring bearers 510f, mothers 510g, fathers 510h, grandmothers 510i, and grandfathers 510j. The user may also specify the seating plan 515 by indicating the number of people seated at the head table 515a and the sweetheart table 515c, the number of guests per table 515b and the number of guest tables needed 515d. The user may also specify the number of floral pieces required for the ceremony 520. For example, the user may specify the number of floral pieces for the following: focal structures 520a, altar pieces 520b, aisle décor 520c, rose petal art 520d, cocktail tables (low) 520e, cocktail tables (high) 520f, escort card table 520g, buffet pieces 520h, sweetheart table 520i, head table 520j, tall pieces 520k, short pieces 5201, the cake 520m and dessert table 520n. The user may view the data entered for the event estimate and modify it. In an embodiment of the invention, when the user modifies the data associated with any of the fields discussed above (e.g., in seating plan 515), the estimated grand total value 505c may be updated to reflect the change in the event estimate based on the modification made by the user. In an embodiment of the invention, one or more values displayed on the Event Estimate Dashboard 500 may be default values that may be retrieved from the Data Store 40 (shown in FIG. 1).

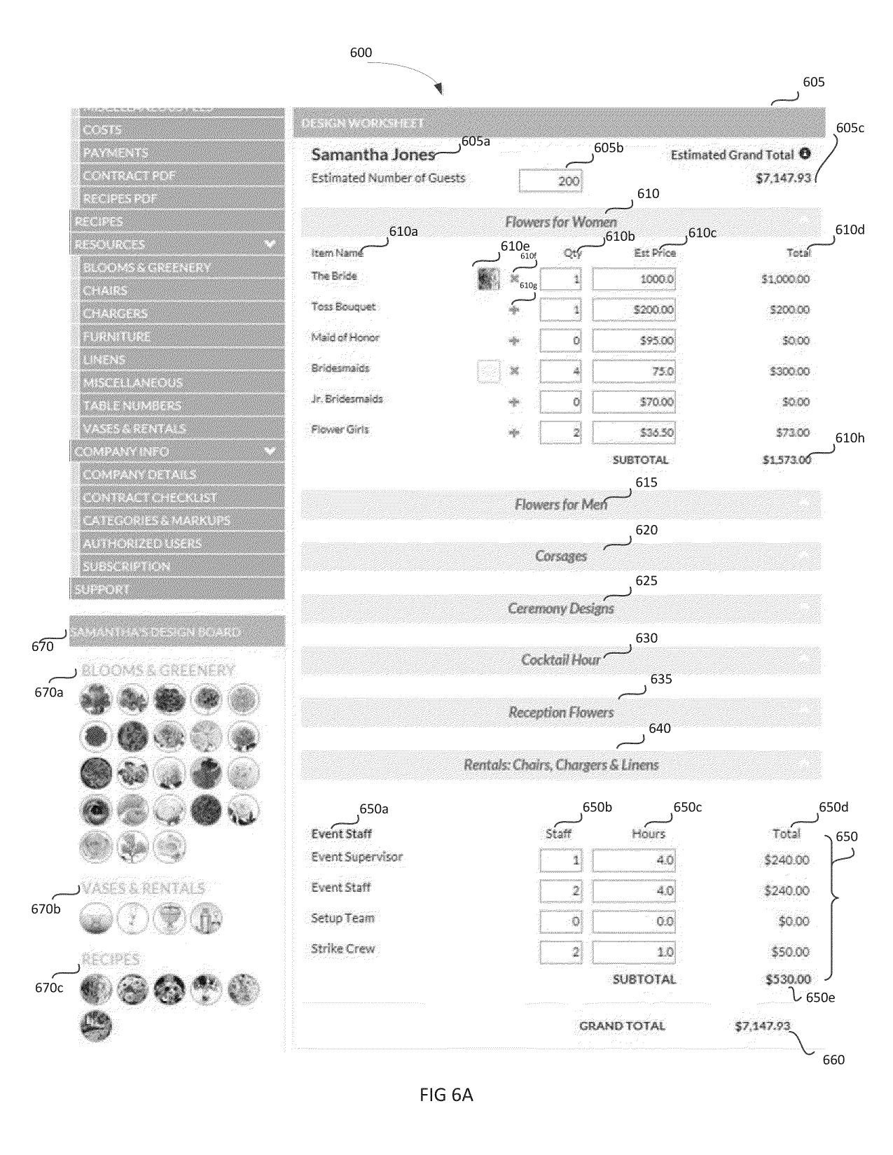

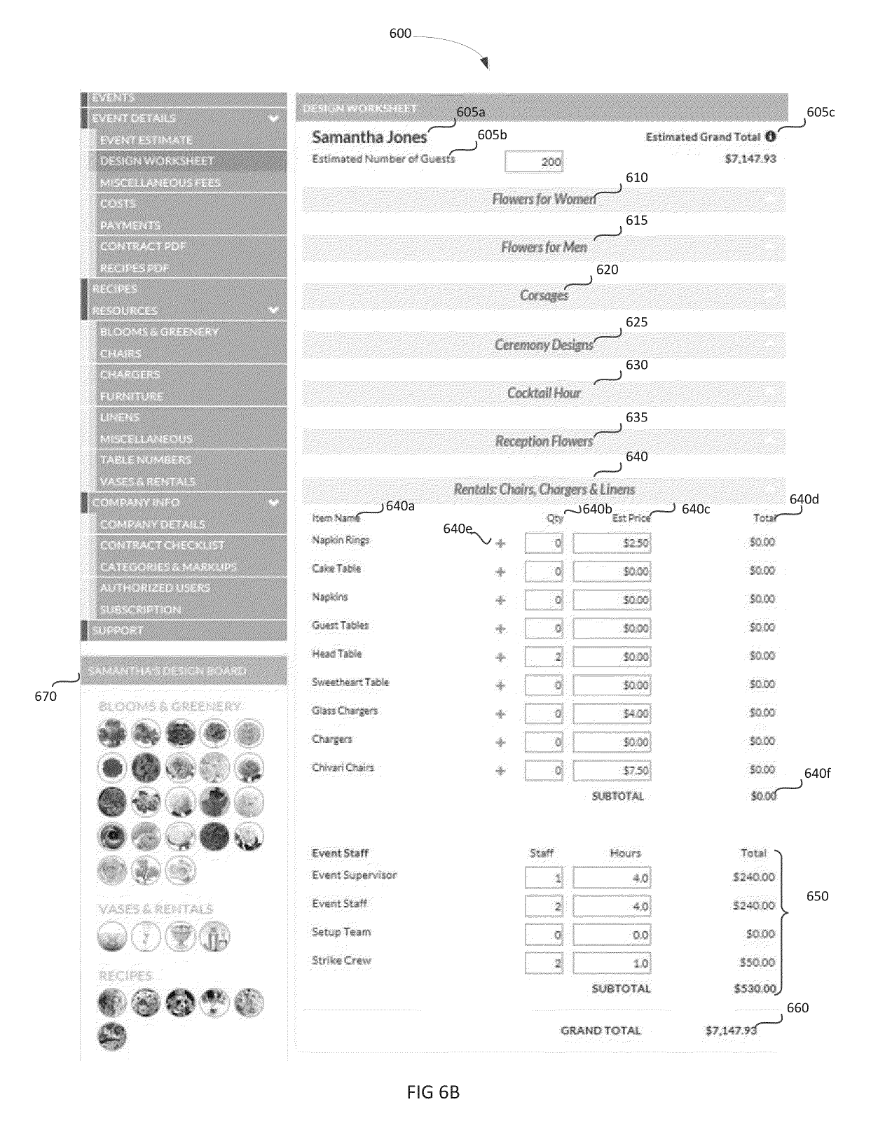

When a user selects the design worksheet button 402b, he/she may be directed to a Design Worksheet dashboard 600 as illustrated in FIG. 6. The Design Worksheet dashboard 600 may comprise a section on the background information of the event 605. It may display the name of the prospect 605a, the estimated number of guests at the event 605b, and the estimated grand total for the event 605c. The user may be able to modify the estimated number of guests 605b. The user may be able to specify one or more details of the design for the event using the Design Worksheet dashboard 600. The details of the design of the event may be illustrated based on one or more groups. For example, for a wedding event, the details of the event may be illustrated using the following grouping: flowers for women 610, flowers for men 615, corsages 620, ceremony designs 625, cocktail hour 630, reception flowers 635, and rentals 640. Each grouping may further display one or more items associated with the group, including the item name 610a, item image 610e, quantity 610b, estimated price 610c and the total price for the item 610d. The Design Worksheet dashboard 600 may also display the subtotal for each group 610h. For example, the group flowers for women 610 may display the following items: the bride, toss bouquet, maid of honor, bridesmaids, junior bridesmaids and flower girls. The user may be able to modify the attributes of each item using the Design Worksheet dashboard 600. For instance, the user may be able to specify a bouquet for the bride by clicking on the image associated with the bride item (610e). Upon clicking the image 610e for the bride, the user may specify the recipe for the bouquet. In an embodiment of the invention, the recipe for the bride bouquet is a default value. In an embodiment of the invention, the user can search for the recipe for the bride bouquet and select one or more alternate options. The user can view the various attributes of the selected bouquet, such as, the price, the ingredients in the recipe, the category of the item, description, cost, etc. In an embodiment of the invention, the user can select one or more recipes from the prospects design board 670 (discussed below). The user may be able to add a recipe for an item using button 610g. The user may be able to delete an item using button 610f.

The Design Worksheet dashboard 600 may also display the details of the event staff 650. For example, the Design Worksheet dashboard 600 may display the position of the event staff 650a (e.g., event supervisor, event staff, setup team, strike crew), number of staff members 650b, number of hours of work for the staff members 650c and the total cost of the staff member(s) 650d. The Design Worksheet dashboard 600 may also display the subtotal for the cost of the event staff 650e. In an embodiment of the invention, when the user modifies the data associated with any of the fields discussed above (e.g., for group flowers for women 610), the estimated grand total value 660 may be updated to reflect the change in the event estimate based on the modification made by the user.

The Design Worksheet dashboard 600 may further display a design board 670 associated with the prospect. Although the design board 670 is shown in FIG. 6, it may be available (and visible) to the user on the other event related dashboard (e.g., the event details dashboard and the event estimate dashboard discussed above). The design board 670 may display one or more items associated with the prospect. The items may be arranged based on one or more categories. For example, for a wedding event, the design board 670 may comprise of a category for Blooms and Greenery 670a, Vases and Rentals 670b, and Recipes 670c. Each category may further comprise of one or more items that have been previously associated with the prospect. FIGS. 12A-12B below illustrate associating one or more items (and categories) with a prospect. A user may be able to associate one or more items in the design board 670 with an item on the design worksheet. For example, the user can associate a recipe for a bouquet (from section 670c) with the toss bouquet item on the design worksheet (section 610).

FIG. 6B is another example of the Design Worksheet dashboard 600. The Design Worksheet dashboard 600 may comprise a section on the background information of the event 605. It may display the name of the prospect 605a, the estimated number of guests at the event 605b, and the estimated grand total for the event 605c. The user may be able to modify the estimated number of guests 605b. The user may be able to specify one or more details of the design for the event using the Design Worksheet dashboard 600. The details of the design of the event may be illustrated based on one or more groups. For instance, the rentals grouping 640 may display the item name 640a, quantity 640b, estimated price 640c and total amount 640d. The user may edit any of these fields. The user may add an item using the field 640e. The sub-total of the group may be displayed at field 640f. The subtotal for the group 640f may be updated when the user modifies an item in the group. The Design Worksheet dashboard 600 may also display the details of the event staff 650. In an embodiment of the invention, when the user modifies the data associated with any of the fields discussed above (e.g., for group flowers for women 610), the estimated grand total value 660 may be updated to reflect the change in the event estimate based on the modification made by the user.

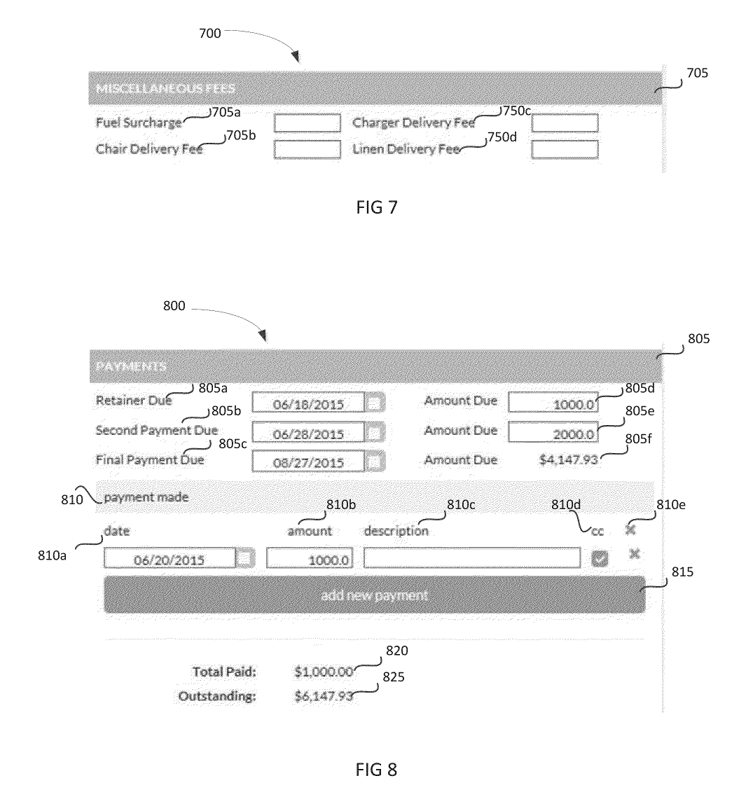

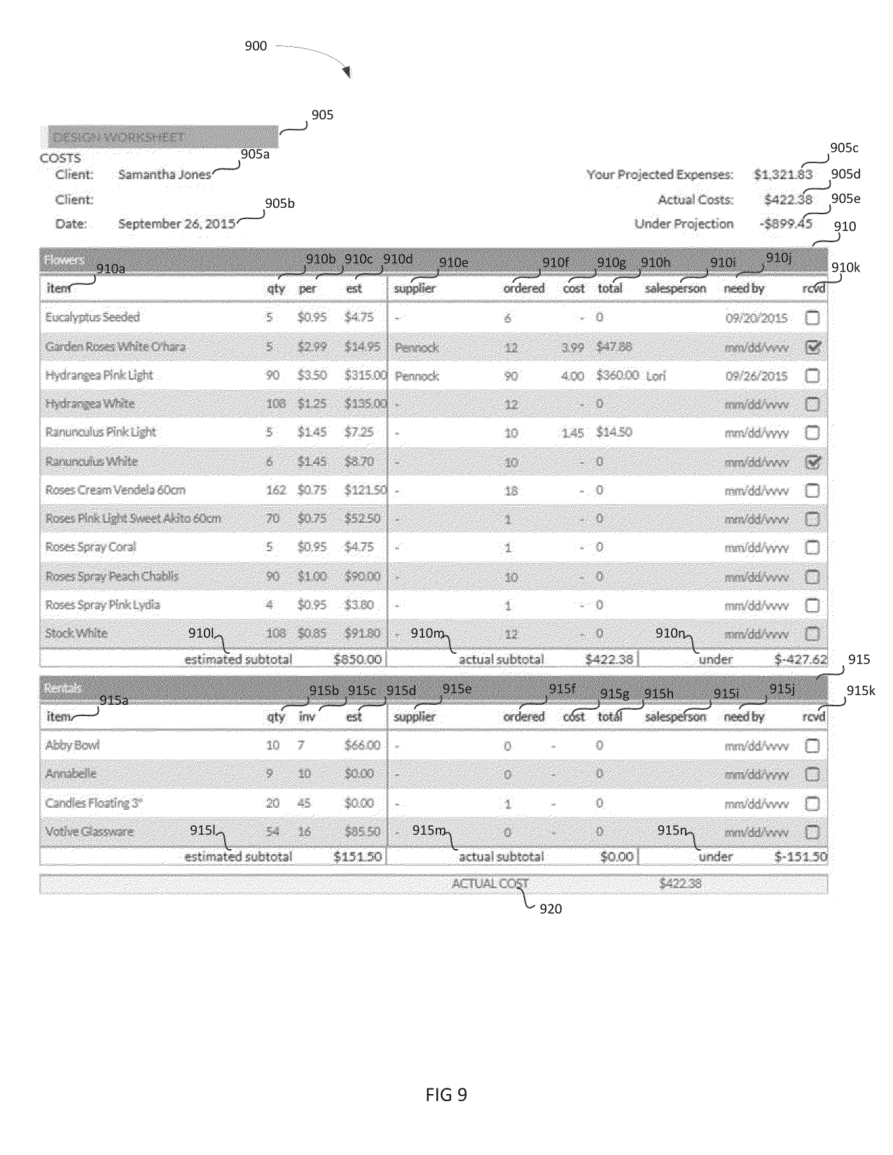

The user may also specify one or more miscellaneous fee items associated with an event using, for example, the miscellaneous fees dashboard 700 described in FIG. 7. The user may specify a value for one or more of the following miscellaneous fees 705 items: fuel surcharge 705a, chair delivery fee 705b, charger delivery fee 705c and linen delivery fee 705. The user may be able to add one or more items to the list of miscellaneous fees 705 items. The user may also be able to record any past and future payments made for an event, using for example, the payments dashboard described in FIG. 8. The user may specify a value for one or more of the following payments items 805: retainer due date 805a, amount due on that date 805d, second payment due date 805b, amount due on that date 805e, final payment due date 805c and amount due on that date 805f. The user may be able to add one or more dates and due amounts to the payment schedule. In an embodiment of the invention, when the user modifies one or more values associated with the due dates and amounts, the final payment due date and amount may be adjusted automatically. The user may also view the list of payments made by the customer (section 810). The user may be able to view the date of the payment 810a, amount 810b, description 810c and whether the payment was made via a credit card 810d. The user may be able to edit the values for the payments made. The user may be able to delete an entry in the payment made log using field 810e. The user may be able to add an entry to the payment made log using button 815. The payments dashboard 800 may display the total amount paid by the customer 820 and the outstanding balance 825.

A user may wish to specify the costs associated with items that are offered to the customer. For example, a wedding planner may wish to specify the cost for the flowers used in various floral arrangements (e.g., bouquets, table pieces, corsages, etc.), the vases used for the arrangements, etc. A user may be able to specify the costs using the costs dashboard described in FIG. 9. FIG. 9 describes a costs dashboard 900 for a prospect. The costs dashboard 900 may display the background information 905 for the customer, including the client name 905a, date of the event 905b, projected expenses 905c, actual costs 905d and the difference between the expenses and the costs 905e. The costs dashboard 900 may further allow a user to view and edit the costs for one or more groups of items. For example, for a wedding planner, the costs dashboard may arrange the items into the following groups: flowers 910 and rentals 915. The user may view the item name (910a and 915a), quantity (910b and 915b), the cost per item 910c, the amount of items in the inventory 915c and the estimate cost for the item (910d and 915d). The user may be able to specify the supplier (910e and 915e) who may supply the item. The value of the supplier (910e and 915e) may be the last supplier who supplied this item. In an embodiment of the invention, the supplier (910e and 915e) may be one of the following: the supplier who can provide the item at the lowest cost, or by a certain date, or the most favorite supplier, etc. In an embodiment of the invention, the user may be able to click on the supplier (910e and 915e) and view one or more selection criteria for selecting the supplier (e.g., lowest cost, fastest delivery, favorite supplier, ranking, peer reviews, etc.). The user may also be able to view the quantity of item ordered (910f and 915f), the cost of each item (910g and 915g), the total cost for the item (910h and 915h), the names of the salesperson (910i and 915i), the date by which the item is needed (910j and 915j) and an indication of whether the item was received (910k and 915k). The user may also view the estimated subtotal for each group of items (910l and 915l), actual subtotal for each group of items (910m and 915m) and the difference between those amounts (910n and 915n). The user may also view the actual total cost for the event 920.

In an embodiment of the invention, upon selecting the indicator of receipt of an item (910k and 915k), the Event Management System may store one or more attributes relating to the item. For example, the Event Management System may store the cost (910g) of the item upon receipt. The Event Management System may then maintain a log of the costs of one or more items. The Event Management System may store a historical view of the attributes of the item upon receipt. For example, the Event Management System may store the historical records of the costs for a particular item. In an embodiment of the invention, the user may search and/or view one or more attributes values (including historical values) for an item.

In addition to providing and viewing information about prospects/clients and related events, a user may also organize and maintain recipes for items that may be used in an event. For example, a user may be able to specify recipes for a particular dish, such as a cake, cookie, etc. In an embodiment of the invention, a user may be able to create a recipe for a layout of a room, such as the layout of a dining room, by specifying various furniture and furnishing pieces and their locations. In an embodiment of the invention, the user may create a recipe for a flower bouquet. The user may be able to maintain and manage recipes using, for example, the recipes dashboard 100 described in FIGS. 10A-10B. The user may be able to view one or more recipes in the recipes section 1015. The recipes may be viewed from various angles (e.g., “flat view,” “top view,” “side view,” etc.) showing a thumbnail image of the recipe 1015a, along with the name 1015b, cost 1015c, markup 1015d, price 1015e and rating 1015f. The user may be able to switch between the various views using button 1011. The user may also navigate from viewing the recipes to a view which contains a larger image of the arrangement and its name (if designated). The user can also delete the recipe using field 1015g. The recipe dashboard 1000 may also include a filter, which allows the user to filter through recipes based on recipe name 1012, ingredient name 1013, colors 1005, categories 1007, styles 1008 and months 1006. When the user selects a filter, one or more filter criteria may be displayed (as shown in FIG. 10C). A user may be able to clear the filter(s) using button 1009.

A user may be able to add a new recipe by selecting button 1010. The user may then be directed to a screen to add a new recipe, for example, as described in FIG. 11. The new recipe dashboard 1100 may allow a user to create a new recipe by providing a recipe name 1105. A user may be able to browse for an existing recipe using field 1110. For example, the user may be able to browse files stored at a file location. The user may be able to browse for previously stored recipes in the Data Store 40 (FIG. 1). The user may be able to specify the ingredients in the recipe by providing their quantity 1115 and their name 1120. The user may be able to browse for one or more ingredient. In an embodiment of the invention, the user may type in the name of the ingredient in field 1120. Field 1120 may use an auto-complete feature to suggest ingredient values based on what has been typed by the user. The user may be able to add ingredients to the recipe using button 1125. The user may be able to provide a description for the recipe using field 1130 and also specify one or more categories for the recipe. Examples of categories include, but are not limited to, bouquets, cakes, chairs, chargers, etc. The user may be able to add a new custom category. In an embodiment of the invention, the user may add one or more tags to the recipe. For example, a cake may be tagged with the following tags: wedding, roses, pink, four-tier, etc. The user may be able to associate one or more styles 1140 with the recipe. Examples of styles include, but are not limited to: beach, birthday, holiday, edgy, elegant, etc. The user may be able to save the recipe using button 1145.

Furthermore, the user may be able to manage one or more resources using, for example, the resources dashboards described in FIGS. 12A-12B. Examples of resource categories include, but are not limited to: blooms & greenery, chairs, chargers, furniture, linens, miscellaneous, table numbers and vases & rentals. A user may be able to view the name of the resource (1205 and 1220). The resources dashboard 1200 may display a list of resources (1215 and 1230) in a resource category which may be viewed from various angles (e.g., “flat view,” “top view,” “side view,” etc.) showing a thumbnail image of each resource (1215e and 1230f), along with the name (1215d and 1230d), cost (1215b and 1230c), inventory (1230b) and rating (1215c and 1230d). The user may be able to switch between the various views using buttons 1205c and 1220c. The resource dashboard 1200 may also include a filter, which allows the user to filter through resources based on item name (1210 and 1225), colors (1205a and 1220a) and months (1205b and 1220b). When the user selects a filter, one or more filter criteria may be displayed. A user may be able to clear the filter(s) using buttons 1205c and 1220c. The user may be able to delete one or more resources from a resource category using fields 1215d and 1230e.

A user may be able to add a new resource by selecting buttons 1205d and 1220d. The user may then be directed to a screen to add a new resource, for example, as described in FIG. 13. The new resource dashboard 1300 may allow a user to create a new resource by providing a resource name 1310 and a resource image 1315. A user may be able to browse for an existing resource using field 1320. For example, the user may be able to browse files stored at a file location. The user may be able to browse for previously stored recipes in the Data Store 40 (FIG. 1). The user may be able to provide a description for the resource using field 1325 and also specify one or more attributes for the resource (e.g., color) using one or more fields. For example, a user may specify the colors for a resource using field 1330. The user may be able to add attributes to the resource using field 1335. In an embodiment of the invention, the user may add one or more tags to the resource. For example, a resource may be tagged with the following tags: blooms & greenery, miscellaneous, vases & rentals. The user may also specify the number of items in inventory 1340. The user may be able to save the recipe using button 1145.

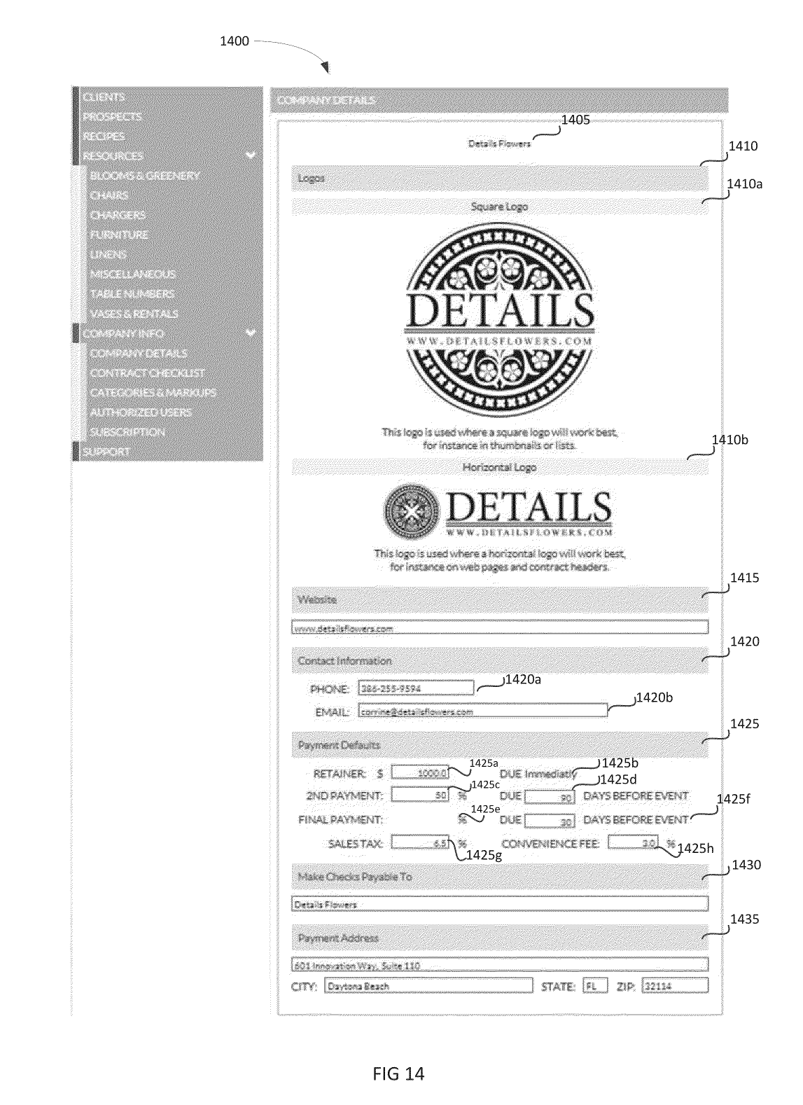

The Event Management System may allow a user to specify one or more attributes about their company. These attributes may be used, for example, when drafting a contract for a client, in determining the cost/markup for an event, etc. FIG. 14 describes a company details dashboard 1400 that allows a user to view and/or edit their company name 1405 and company logo(s) 1410. The user may specify one or more logos for his/her company (1410a and 1410b). The user may also specify their website 1415 and contact information 1420 (phone number 1420a and email address 1420b). The user may specify defaults for their payment strategy 1425. For example, the user may specify the amount of the retainer 1425a, when it is due 1425b, amount of the second payment 1425c, when it is due 1425d, amount of final payment 1425e and when it is due 1425f. The amount due may be specified in terms of percentage or dollars. The user may further specify the default sales tax 1425g and convenience fees to charge a client 1425h. The user may also specify the payee 1430 to which any payment checks may be addressed to. Additional payment address information 1435 may be provided by the user.

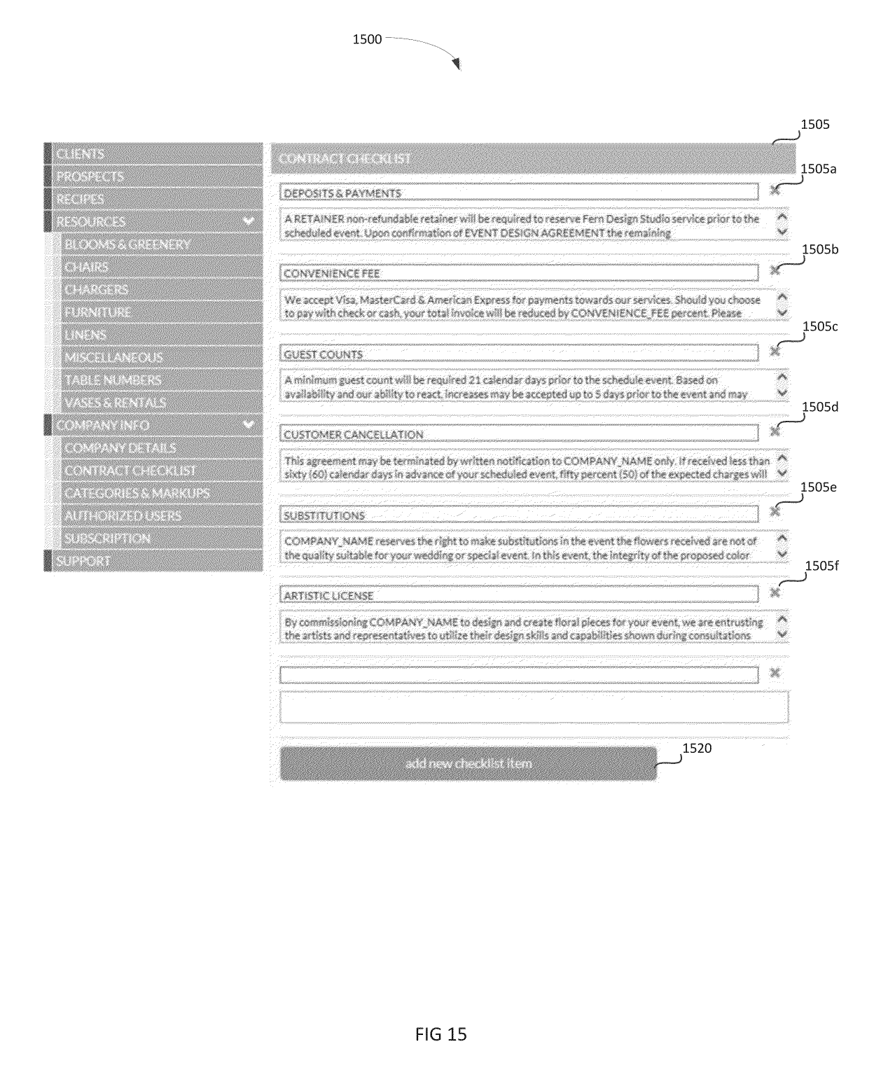

The Event Management System may allow a user to specify one or more items for their contracts. FIG. 15 describes a contract checklist dashboard 1500 that allows the user to view and/or edit a contract checklist 1505. The user may add one or more checklist items for the following categories: deposits and payments 1505a, convenience fee 1505b, guest counts 1505c, customer cancellation 1505d, substitutions 1505e and artistic license 1505f. The checklist items may be added as terms of the final contract between the company and a prospect/client. The user may add a new checklist item using button 1520.

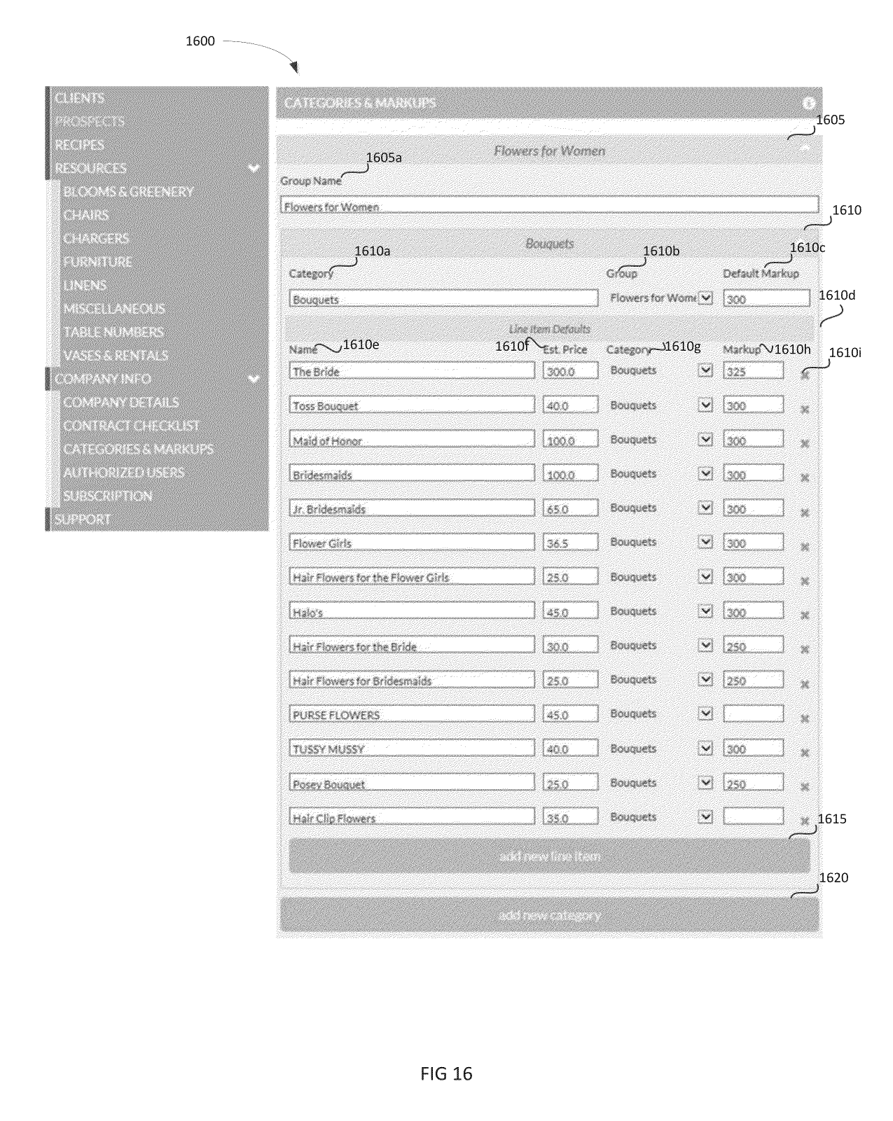

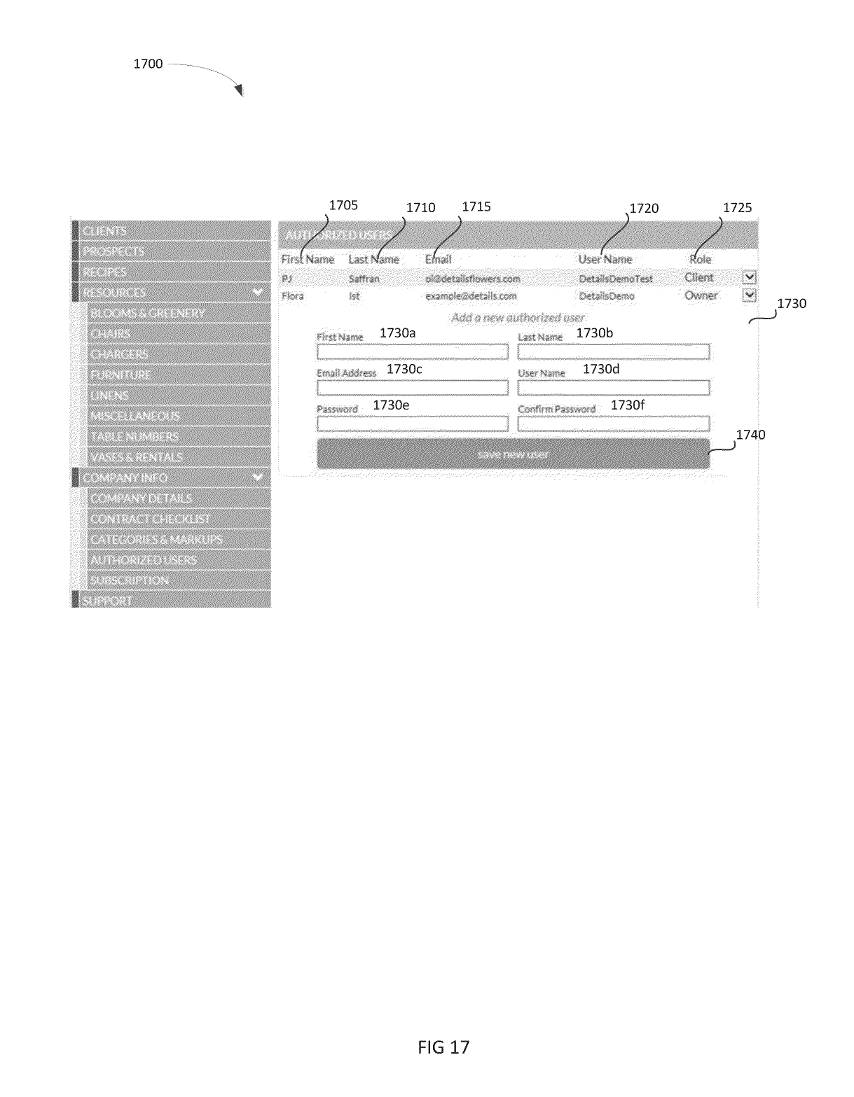

The Event Management System may allow a user to manage the categories for one or more designs and markups for items in a design. FIG. 16 describes a categories and markups dashboard 1600 that allows a user to manage categories and markups. For example, the user may be able to view and/or edit the details about a group 1605 including the group name 1605. The user may be able to view one or more item categories 1610 under a group. For example, for the group flowers for women, the categories and markup dashboard 1600 may display the category item bouquets 1610. The user may be able to view and/or modify the category of the item 1610a, the group that the item belongs to 1610b and the default markup value for the item 1610c. The user may further view and/or modify one or more list item defaults 1610. The list item defaults section 1610 may display one or more items that are associated with the category, including the following information about the items: name 1610e, estimated price 1610f, category 1610g and markup value 1610h. The user may be able to delete one or more associated items using field 1610i. The user may add a new item to the category using button 1615. The user may also add a new category using button 1620.

The Event Management System may allow a user to manage the privileges and roles for one or more users who may access the Event Management System. FIG. 17 describes an authorized users dashboard 1700 that lists the users who may have access to the Event Management System. A user may modify one or more attributes for the users including, but not limited to, first name 1705, last name 1710, email address 1715, user name 1720 and role 1725. The role for the user may be, for example, owner, employee, manager, client and prospect. The user may be able to add a new authorized user using button 1730 by using the first name 1730a, last name 1730b, email address 1730c, user name 1730d, password 1730e and confirm password 1730f fields. The user may then save a new user using button 1740.

The user may also enter a “Supplies” view in embodiments of the invention which provides for miscellaneous supplies for the event including candles, balloons, baskets, bowls, etc. There may also be, e.g., a “Vases” dropdown menu in the supplies category and this contains vases, shells and other centerpieces which are all displayed similar to the miscellaneous and the rentals pieces.

Further dropdown menus may also list, e.g., suppliers, colors, categories, styles, item types and contact phone numbers. When the user selects a suppliers option, for instance, a list of the name, user rating and average rating are displayed. The user can also edit the different clients listed and add another client. When the user selects a name, the user rating, the average rating and the cost rating appear. These dropdown menus may also include a “Colors” view or page. In this view, a user may view a list of the current colors for blooms or recipes, along with a description. Colors preferences can be added and modified as well (e.g., “More yellow,” “No pink”). The dropdown menu may further include a “Categories” view which contains various categories for each of the different ingredients in the recipe/event. In embodiments of the invention, there may be a description of each category along with markup and the ability to delete and add a new category.

In embodiments of the invention, a “Personnel/Team” function allows the user to view the team assigned to the event and what each team member has completed in a log. The complete order form may include a list of everything ordered and the price information, along with the company it was ordered from, and an estimate and actual cost. The recipe function allows different recipes to be added to the event and the search includes a filter involving the name, type month and category of the recipe.

Further embodiments of a web-site operated in accordance with an embodiment of the invention may also include a Client Management Dashboard (“CMD”). The CMD may include, for instance, a main dashboard which appears showing a list of the clients and their projects. The CMD may also include a calendar, along with information relating to the client name, location and number of guests for each event. The CMD may also include a “Prospects” view with information related to potential clients, as well as information related to venues and professionals, portfolios with past events, a recipe index and resource guide. Further, if a user selects the name of the client via the CMD, the system may also display a list of the client detail information, event details information, VIP information for specified guests and/or other event vendors.

The individual client information may include client-designed recipes, a listing of their complete order with a vendor, the personnel and team assigned to their event, the contract or event design agreement associated with the order, a summary of the order, and a room diagram. The room diagram can be customized based on table arrangements and floral arrangements within the event management platform. The platform may also include a calendar indicating what events have occurred in the chain leading up to the actual events, such as when the final deposit is due and if/when a rehearsal is needed. The screen indicates a total amount, the deposit, the projected floral expenses and the actual floral expenses along with sales tax and profit for the employees and the items. An “Agreement” view may show the agreement with the parties, the dates, the event schedule and the cost information for the event, as well as the number of hours for each person working the event, a cost break down and a payment schedule. Payment terms included in the agreement, relating to deposit, credit card fees, guest attendance, guest counts, customer cancellations, substitutions, artistic license and photographic and permitted uses may also be shown, which can be customized based on the event.

As described above, embodiments of the system of the invention and various processes of embodiments are described. The system of the invention or portions of the system of the invention may be in the form of a “processing machine,” i.e. a tangibly embodied machine, such as a general purpose computer or a special purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as any of the processing as described herein. Such a set of instructions for performing a particular task may be characterized as a program, software program, or simply software.

As noted above, the processing machine, which may be constituted, for example, by the particular system and/or systems described above, executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize (or be in the form of) any of a wide variety of other technologies including a special purpose computer, a computer system including a microcomputer, mini-computer or mainframe for example, a programmed microprocessor, a micro-controller, a CPU (Central Processing Unit) a peripheral integrated circuit element, a CSIC (Consumer Specific Integrated Circuit) or ASIC (Application Specific Integrated Circuit) or other integrated circuit, a logic circuit, a digital signal processor, a programmable logic device such as a such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The processing machine used to implement the invention may utilize a suitable operating system. Thus, embodiments of the invention may include a processing machine running the Microsoft Windows™ Vista™ operating system, the Microsoft Windows™ XP™ operating system, the Microsoft Windows™ NT™ operating system, the Windows™ 2000 operating system, the Unix operating system, the Linux operating system, the Xenix operating system, the IBM AIX™ operating system, the Hewlett-Packard UX™ operating system, the Novell Netware™ operating system, the Sun Microsystems Solaris™ operating system, the OS/2™ operating system, the BeOS™ operating system, the Macintosh operating system, the Apache operating system, an OpenStep™ operating system or another operating system or platform.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

Various networks may be implemented in accordance with embodiments of the invention, including a wired or wireless local area network (LAN) and a wide area network (WAN), the Internet, wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism.

Computers may be connected over the Internet, an Intranet, Extranet, Ethernet, or any other system that provides communications. Some suitable communication protocols may include TCP/IP, UDP, or OSI, for example. For wireless communications, communication protocols may include Bluetooth, Zigbee, IrDa, Wi-Fi, 2G, 3G, Ultra-Wideband and Long Term Evolution (LTE) or other suitable protocols. The wireless communication protocol may also include short-range communication devices and protocols, such as RFID, or Near-Field Communication radio transmissions. Furthermore, components of the system may communicate through a combination of wired or wireless paths.

Although many other internal components of the computer are not shown, those of ordinary skill in the art will appreciate that such components and the interconnections are well known. Accordingly, additional details concerning the internal construction of the computer need not be disclosed in connection with the present invention.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, a EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

The memory will include at least one set of instructions that is either permanently or temporarily stored. The processor executes the instructions that are stored in order to process data. The set of instructions may include various instructions that perform a particular task or tasks, such as those shown in the appended flowchart. Such a set of instructions for performing a particular task may be characterized as a program, software program, software, engine, module, component, mechanism, or tool. The computer may include a plurality of software processing modules stored in a memory as described above and executed on a processor in the manner described herein. The program modules may be in the form of any suitable programming language, which is converted to machine language or object code to allow the processor or processors to read the instructions.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media is typically connected to the system bus through a removable or non-removable memory interface.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

In the system and method of the invention, a variety of “user interfaces” may be utilized to allow a user to interface with the processing machine or machines that are used to implement the invention. A user may enter commands and information into the computer through a user interface. The user interface may include any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the invention, it is not necessary that a human user actually interact with a user interface used by the processing machine of the invention. Rather, it is also contemplated that the user interface of the invention might interact, i.e., convey and receive information, with another processing machine, rather than a human user. Further, it is contemplated that a user interface utilized in the invention may interact partially with another processing machine or processing machines, while also interacting partially with a human user.

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

Further, the embodiments of the invention described herein may be applied to a mobile or portable device. Mobile devices or portable devices can take various forms. In one approach, the mobile device may be a personal device that the customer owns, such as a personal smartphone or tablet, and brings into the physical store. As described in more detail below, mobile devices may include mobile personal computers, such as laptops, notebooks, netbooks, tablets (e.g., iPad, Samsung Galaxy Tab 10.7, Google Nexus 10, mini-iPad, Samsung Galaxy 7.7, Google Nexus 7, Amazon Kindle and Kindle Fire etc.), PDAs (personal digital assistants), smart phones (e.g., the iPhone, Samsung S3, Samsung S4, Samsung Note 2, etc.), and other forms of portable computer devices. Mobile devices that can support wireless communications such as NFC or RFID can communicate using those capabilities

The mobile device may be programmed with a software application that enables the mobile device to communicate to the vendor. In one embodiment, the software application may be a mobile app developed by the vendor, and distributed to customers through an app store such as Apple iTunes, or Google Play. In other embodiments of the invention, the software application may be a third-party application, such as a mobile browser, connected to a web app hosted by the vendor. For example, the software application may be a mobile browser such as the Safari Mobile Browser, connected to a website. In other embodiments, the software application may also be specialized native software designed for use on mobile devices. In these embodiments, the software applications may be installed and maintained privately, without being distributed through a public third party app distributor, such as Apple iTunes, or Google Play.

Generally, it should be noted that the components depicted and described herein above may be, or include, a computer or multiple computers. Although the components are shown as discrete units, all components may be interconnected or combined. The components may be described in the general context of computer-executable instructions, such as program modules, being executed by a computer. Generally, program modules include routines, programs, objects, applications, components, data structures, etc., that perform particular tasks or implement particular abstract data types.

Those skilled in the art will appreciate that the invention may be practiced with various computer system configurations, including hand-held wireless devices such as mobile phones, tablets or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications and equivalent arrangements.

1. A computer-implemented centralized event management system for managing information associated with an event, the system comprising:
an electronic display for presenting vendor information to a user, the vendor information comprising data related to at least one floral arrangement for the event;
at least one user input device for allowing manipulation and selection of user options, the user options being associated with the event;
a database for storing the vendor information and additional information relating to client preferences; and
computer processing components programmed to integrate the vendor information with client preferences and information relating to flower cost into a single event record, wherein the event record is processed by the computer processing components to automatically generate a total cost for the event.

2. The event management system of claim 1 wherein the electronic display receives at least one datum about the event from the user.

3. The event management system of claim 1 wherein the electronic display receives at least one datum about the vendor team associated with the event.

4. The event management system of claim 1 wherein the electronic display receives at least one datum about at least one design associated with the event from the user.

5. The event management system of claim 1 wherein the electronic display presents a design board, the design board comprising at least one category of objects associated with the event.

6. The event management system of claim 1 wherein the electronic display receives at least one datum about at least one payment for the event from the user.

7. The event management system of claim 1 wherein the electronic display presents a design worksheet.

8. The event management system of claim 7 wherein the design worksheet displays at least one item for the event, the design worksheet comprising at least one of:
item name;
item quantity;
cost per item;
item supplier
ordered items; and
total amount for the design.

9. The event management system of claim 1 wherein the electronic display receives and stores at least one datum for at least one resource.

10. The event management system of claim 1 wherein the electronic display receives at least one contract term for a contract between the user and a client.

11. A computer based event management method for managing information associated with an event, the method comprising:
displaying, using an electronic display, vendor information to a user, the vendor information comprising data related to at least one floral arrangement for the event;
manipulating and selecting user options using at least one user input device, the user options being associated with the event;
storing, using a database, the vendor information and additional information relating to client preferences; and
integrating, using computer processing component, the vendor information with client preferences and information relating to flower cost into a single event record, wherein the event record is processed by the computer processing components to automatically generate a total cost for the event.

12. The event management method of claim 11 wherein the electronic display receives at least one datum about the event from the user.

13. The event management method of claim 11 wherein the electronic display receives at least one datum about the vendor team associated with the event.

14. The event management method of claim 11 wherein the electronic display receives at least one datum about at least one design associated with the event from the user.

15. The event management method of claim 11 wherein the electronic display presents a design board, the design board comprising at least one category of objects associated with the event.

16. The event management method of claim 11 wherein the electronic display receives at least one datum about at least one payment for the event from the user.

17. The event management method of claim 11 wherein the electronic display presents a design worksheet.

18. The event management method of claim 17 wherein the design worksheet displays at least one item for the event, the design worksheet comprising at least one of:
item name;
item quantity;
cost per item;
item supplier
ordered items; and
total amount for the design.

19. The event management method of claim 11 wherein the electronic display receives and stores at least one datum for at least one resource.

20. The event management method of claim 11 wherein the electronic display receives at least one contract term for a contract between the user and a client.
